(19) United States
(12) Patent Application Publication
(10) Pub. No.: US 2023/0189817 A1
(43) Pub. Date: Jun. 22, 2023

(54) AGRICULTURAL COMPOSITIONS COMPRISING MICROBIAL CONSORTIA, AND METHODS OF USE THEREOF

(71) Applicant: Microbes, Inc., The Woodlands, TX (US)

(72) Inventors: Robert West, Missouri City, TX (US); Brian W. Pusch, East Aurora, NY (US)

(21) Appl. No.: 18/081,431

(22) Filed: Dec. 14, 2022

Related U.S. Application Data
(60) Provisional application No. 63/289,594, filed on Dec. 14, 2021.

(51) Int. Cl. A01N 63/27; A01N 63/22; A01N 63/20; A01N 25/02; A01P 21/00

(52) U.S. Cl. CPC A01N 63/27; A01N 63/22; A01N 63/20; A01N 25/02; A01P 21/00

(57) ABSTRACT

The invention relates to compositions including a microbial consortium, for example a microbial consortium that includes at least one of the following isolated microbes: Pseudomonas putida, Bacillus mojavensis, Rhodopseudomonas palustris, Pseudomonas protegens, and Lactobacillus plantarum. The invention also includes formulations that include such compositions, and methods for the use of such formulations.

### RELATED APPLICATION

This application claims the benefit of U.S. Provisional Application No. 63/289,594, filed on Dec. 14, 2021. The entire teachings of the above application are incorporated herein by reference.

### FIELD OF THE APPLICATION

This application relates to biostimulant and soil amendment formulations to increase potassium availability and uptake.

### BACKGROUND OF THE INVENTION

Potassium (K) is an essential macronutrient for plants, integral to many cell functions. Because K is not metabolized into organic compounds in the plant, it is present in its cationic form within the plant cells, and thereby can act as a regulator for key physiological and biochemical processes, including enzyme activation, water regulation and cell osmotic potential regulation, cell pH stabilization, plant growth regulation, photosynthesis, and stomatal regulation. These functions are all interconnected in the physiology of a healthy plant.

For example, potassium is directly involved in maintaining the electrochemical gradient of the plasma membrane for plant cells, which affects a number of membrane-bound proteins that carry out other essential functions, such as opening and closing stomata in the guard cells in the plant epidermis, which can in turn affect photosynthesis and growth of pollen tubes for sexual reproduction. As another example, potassium's effects on osmoregulation and water uptake in turn affects the turgor in the plant cell and its structural integrity. Importantly, potassium activates or regulates numerous enzymes necessary for plant metabolism activities, including protein synthesis, nitrogen and carbon usage, sugar transport, energy production, and photosynthesis. Potassium is integrally involved in plant growth, not only by regulating metabolism, but also by controlling ATPase in the plasma membrane to trigger hydrolase activity. Its effects on intracellular metabolism impact seed germination as well, complemented by its ability to enhance water imbibition to facilitate rapid growth.

Because of its effects on biosynthesis, water regulation, and metabolite distribution, potassium is recognized as an important factor in increasing crop yield and quality, and thus for enhancing nutritional food security. Certain high-value crops have greater potassium needs than others, however. Plant species differ in their needs for potassium supplementation for various reasons, including their ability to acquire K from the soil, their ability to use K efficiently for growth or reproduction, and their level of K requirements to optimize the crop's harvest index.

As an example, certain crop species can benefit from increased potassium in their early stages of growth. Representative species include potatoes, tomatoes, winter squash, asparagus, barley, alfalfa, canola, chickpeas, and the like. As another example, certain species of fruit trees have high demands for potassium in order to produce high yields of large, ripe fruits. Representative species include Prunus dulcis (almond tree), Prunus persica (peach tree), Prunus avium (sweet cherry tree), Prunus cerasus (sour cherry tree), Prunus domestica (plum tree), Prunus armenaica (apricot tree), and the like. Inadequate potassium can cause poor color in fruit, small fruits and low yield, low sugar levels, slow ripening, impaired tree growth, and greater susceptibility to damage.

Besides playing a key role in the growth and maintenance of healthy plants, potassium levels can significantly affect the plants' ability to resist abiotic stress conditions such as low or high temperatures, deficient or excessive water, high salinity, heavy metal exposure, and ultraviolet radiation. Environmental stresses. such as drought and heat reduce photosynthetic rates and rates of intracellular energy production. Decreased efficiency of photosynthesis in turn increases the production of reactive oxygen species that can damage the plant. Chloroplasts experiencing water deficient stress can lose essential potassium, which suppresses photosynthesis further. The effects of these stress conditions on plants can be counteracted by maintaining optimum levels of potassium, in part because of its beneficial effects on photosynthesis. High salt levels affect plants adversely as well, in part by affecting the osmotic balance within the plant, and in part by impacting photosynthesis. High concentrations of sodium in the soil also reduce potassium uptake, thus accelerating the adverse effects of salt stress. These conditions of high or increasing soil salinity can occur from a variety of causes. For example, certain soils have naturally high salinity, while in some geographic areas soil salinity has increased from years or decades of irrigation using ground water that had not been tested for salinity and itself carried high level of salts that remain in the soil. Coastal agricultural areas affected by adjacent salt water bodies also suffer harmful impacts from salinity in the soil. Soil salinity, in turn, leads to an increasing risk to crop productivity.

Soils are termed salt affected if the concentration of soluble salts in the soil prohibits or hinders plant growth. The term salt is used as a general term that describes salts from nine main salt compounds found in the soil environment: the most common salts in soils consist of the cations sodium (Na⁺), calcium (Ca²⁺), and magnesium (Mg²⁺) and the anions chloride (Cl⁻), sulfate (SO₄²⁻), and carbonate (CO₃²⁻). Two general terms in salt classification are saline and sodic: saline soils are soils with high amounts of all salts, whereas sodic soils are high in one specific salt, sodium. Replenishing potassium can counteract the damaging effects of salt stress for plants exposed to salt-affected soil.

In addition, biotic stress resistance, for example disease resistance, can be linked to adequate potassium levels, in part because potassium promotes the synthesis of starches, cellulose, and proteins that maintain healthy cell architecture while suppressing the formation of small molecules like sugars and organic acids that provide nourishment for damaging insects and microbes.

Obtaining adequate potassium, therefore, is a critical aspect of agronomy. Unfortunately, the amount of soluble potassium in the soil is quite low, with only about 1-2% of this element in a form that is available to plants; the potassium in the soil is overwhelmingly found in insoluble form, captured in rocks, minerals, or other deposits. For example, crystalline structures of mica, feldspar, and clays are repositories of biologically unavailable potassium. Releasing this material into the soil for plant uptake depends on weathering and dissolution processes, with long timeframes. While the soil contains some soluble K that is available to plants, large regions of cultivated land have inadequate potassium supply for the crops that they support.

Potassium therefore is commonly added to soils through chemical fertilizers, especially those prepared from mined or manufactured potash-containing minerals such as potassium carbonate, potassium chloride (KCl), potassium sulfate, or potassium nitrate. Potassium silicate materials have also been used as fertilizers. Of these chemical fertilizers, KCl is the cheapest and most frequently used. Some crops are sensitive to the chloride ion though, requiring the use of more expensive potassium sources. The overall availability of potassium from an applied fertilizer can be low, depending on factors that include soil composition, moisture content, pH and other local factors.

Furthermore, on a global scale, it has been observed that there is an imbalance between potassium demand and its available supply through chemical fertilizers, especially in developing countries. In developing countries, fertilizers may not be affordable, contributing to the problem of global food insecurity. Moreover, with the rapid increase in agricultural production worldwide, crop harvest practices have depleted the availability of potassium, and soils are adversely affected by environmental factors such as runoff, erosion, and leaching. Alternatives to or adjuncts to conventional potassium fertilizer practices are therefore desirable, in order to provide levels of this essential nutrient as required by burgeoning global demands for sustainable agriculture.

Besides potassium, there are two other essential macronutrients for plant growth and development: nitrogen and phosphorus. Nitrogen is essential for plant growth and development because of its fundamental role in protein synthesis and energy metabolism. It is required for photosynthesis and chlorophyll formation, as well as other activities that support plant vigor and resilience. Among all of the nutrients that interact with potassium, nitrogen is the most significant: K levels can affect nitrogen uptake and utilization, thus impacting plant growth and development through its effect on the functioning of nitrogen. Phosphorus is involved in root growth and flowering. It is also involved in energy transfer and photosynthesis. Nitrogen, phosphorus, and potassium, along with many other nutrient materials called micronutrients, are all absorbed by the plant from the soil.

It is known in the art that microorganisms, including bacteria, fungi, and actinomycetes, can solubilize silicate materials in the soil and release nutrients that are complexed in these minerals. This is the main mechanism by which plants obtain potassium and phosphate in the natural environment (i.e., without human supplementation). The mechanism by which microorganisms increase the bioavailability of potassium and phosphate in the soil appears to be by producing acids that hydrolyze the silicate minerals. The use of microorganisms therefore can provide these nutrients to plants simply by accelerating the natural decomposition of minerals that contain these nutrients, thereby increasing their levels in the soil without adding exogenous fertilizers to the ecosystem and thus disturbing its composition. Similar microorganism-based mechanisms can release other nutrients that are bound to minerals in the soil. These practices potentially cause less disruption of the environment, while bringing about agricultural benefit. While the use of microorganisms can be employed to increase available potassium for crop production, these practices have not been extensively developed for use in the industry. In part, appropriate microorganisms have not been identified for this specific purpose, and efficient strains have not been identified. Moreover, formulations have not been developed to sustain the strains once identified and to deliver them to their agricultural targets.

There remains a need in the art, therefore, for technologies to improve the availability of potassium for plants, especially crop-producing plants. There remains a further need in the art for alternatives to the use of potassium fertilizers that is predominant in the industry, or for adjuncts that improve the availability of potassium as provided via potassium fertilizers. This need is rendered especially acute in view of the current global requirement for increased crop production plus the high cost of conventional potassium fertilizers, both exacerbated by concerns about increasing environmental stresses. Advantageously, this alternative technology can support healthy plant growth and increasing yields in a sustainable and environmentally responsible way.

### SUMMARY OF THE INVENTION

Disclosed herein, in embodiments, are compositions comprising a microbial consortium, the microbial consortium comprising a plurality of isolated microbes, wherein the isolated microbes comprise at least one, two, three, four or five of Pseudomonas putida, Bacillus mojavensis, Rhodopseudomonas palustris, Pseudomonas protegens, and Lactobacillus plantarum. In embodiments, the microbial consortium consists essentially of Pseudomonas putida, Bacillus mojavensis, Rhodopseudomonas palustris, Pseudomonas protegens, and Lactobacillus plantarum. In embodiments, the microbial consortium further comprises at least one of Paenibacillus durus and Bacillus firmus. In embodiments, the microbial consortium comprises at least one, preferably at least two, microbes selected from the group consisting of Pseudomonas fluorescens, Bacillus coagulans, Bacillus amyloliquefaciens, Bacillus subtilis, Bacillus lichenformis, Bacillus brevis, Alicaligenes faecalis, Pseudomonas denitrificans, Burkholderia spp., Bacillus pumilus, Bacillus cereus, Bacillus megaterium, and Bacillus thuringiensis; in other embodiments, the microbial consortium does not comprise Paenibacillus durus or Bacillus firmus. In embodiments, the microbial consortium further comprises a microbe selected from the group consisting of Pseudomonas fluorescens, Bacillus coagulans, Bacillus amyloliquefaciens, Bacillus subtilis, Bacillus lichenformis, Bacillus brevis, Alicaligenes faecalis, Pseudomonas denitrificans, Burkholderia spp., Bacillus pumilus, Bacillus cereus, Bacillus megaterium, and Bacillus thuringiensis.

Also disclosed herein, in embodiments, are formulations comprising a composition and an agriculturally compatible carrier, wherein the composition comprises a microbial consortium comprising a plurality of isolated microbes, and wherein the isolated microbes comprise one, two, three, four or five of Pseudomonas putida, Bacillus mojavensis, Rhodopseudomonas palustris, Pseudomonas protegens, and Lactobacillus plantarum. In embodiments, the formulation is a fluid formulation, which can be selected from the group consisting of a liquid, an emulsion, a suspension, a solution, a gel, an irrigation vehicle, a spray vehicle, and a seed coating vehicle. In other embodiments, the formulation is a solid formulation, which can be selected from the group consisting of a wettable powder, a solid powder, a dusting powder, a tablet, water-dispersible granules, water-soluble granules, and microencapsulated granules. In embodiments, the agriculturally compatible carrier is an aqueous carrier. In embodiments, the formulation further comprises an agriculturally compatible additive, which can be selected from the group consisting of preservatives, surfactants, emulsifiers, stabilizers, buffers, acidifiers or alkalinizing agents, nutrients, thickening agents, gelling agents, dispersants, antifreeze agents, dyes, colorants, pesticides, herbicides, insecticides, fungicides, and antibacterial agents. In embodiments, the additive is citric acid.

Further disclosed herein, in embodiments, are methods of treating an agricultural target, comprising delivering a treatment to the agricultural target comprising an amount of a formulation, as described above, in an effective amount for obtaining a desired result, thereby producing a treated agricultural target demonstrating the desired result. In embodiments, the desired result is an improvement of a pathological condition or an avoidance of the pathological condition, and the pathological condition can be selected from the group consisting of a disease state, an infection, a chemical exposure, a lack of adequate water, and an exposure to excess heat or cold. In embodiments, the desired result is an enhancement of a healthy condition; the enhancement of the healthy condition can be identified by comparing a state of the treated agricultural target with the state of a control agricultural target, wherein the control agricultural target has been exposed to conditions similar to those for the treated agricultural target, but without receiving the treatment. Also disclosed herein, in embodiments, are methods of effecting a beneficial agronomic effect in an agricultural target, comprising delivering an effective amount of a formulation comprising a composition as described above and an agriculturally compatible carrier to the agricultural target, wherein the beneficial agronomic effect is selected from the group consisting of an improvement in growth, an increase in yield, improved metabolism, improved stress tolerance. and improvement in plant product composition.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A and FIG. 1B depict Alexsandrov agar plates showing growth of microbial consortia after 7 and 14 days, respectively.

FIG. 2 is a graph showing percentages of micronutrients in plant tissue under experimental and control conditions.

FIG. 3 is a graph showing amounts of micronutrients in plant tissue (in ppm) under experimental and control conditions.

FIG. 4 is a graph showing the height of tomato plants under experimental and control conditions.

FIG. 5 is a graph showing the number of flowers tomato plants under experimental and control conditions.

FIG. 6 is a graph showing the height of lettuce plants under experimental and control conditions.

FIG. 7 is a graph showing the height of lettuce plants under experimental and control conditions.

FIG. 8 is a graph showing the length of lettuce tap roots under experimental and control conditions.

FIGS. 9A, 9B, 9C and 9D present photographs showing citrus trees under control (untreated) conditions (FIGS. 9A and 9B) and experimental (treated) conditions (FIGS. 9C and 9D).

FIGS. 10A and 10B present photographs showing a first citrus tree under control (untreated) conditions (FIG. 10A) and a second citrus tree under experimental (treated) conditions (FIG. 10B).

FIGS. 11A and 11B present photographs showing a first citrus tree under control (untreated) conditions (FIG. 11A) and a second citrus tree under experimental (treated) conditions (FIG. 11B).

FIG. 12 depicts a bar graph showing the potassium available for immediate uptake in soil samples from test populations and control populations.

FIG. 13 depicts a bar graph showing potassium available for immediate uptake vs potassium reserves in soil samples from test populations and control populations.

FIG. 14 depicts a bar graph showing amount of soil nitrate and phosphate available for uptake in test populations and control populations.

FIG. 15 depicts a bar graph showing the amount of soil sodium, calcium, and magnesium available for uptake (ppm) in test populations and control populations.

FIG. 16 depicts a bar graph showing amount of soil micronutrients zinc, iron, manganese, copper, and boron available for uptake (ppm) in test populations and control populations.

FIG. 17 depicts a bar graph showing percent of potassium in tissue samples in test populations and control populations.

FIG. 18 depicts a bar graph showing percent phosphate in tissue samples in test populations and control populations.

FIG. 19 depicts a bar graph showing percent nitrogen in tissue samples in test populations and control populations.

FIG. 20 depicts a bar graph showing amounts (ppm) of sulfur, calcium, and magnesium in tissue samples in test populations and control populations.

FIG. 21 depicts a bar graph showing percent potassium in tissue samples in test populations and control populations.

FIG. 22 depicts a bar graph showing percent phosphate in tissue samples in test populations and control populations.

FIG. 23 depicts a bar graph showing percent nitrogen in tissue samples in test populations and control populations.

FIG. 24 depicts a bar graph showing amounts of sulfur, calcium, and magnesium (ppm) in test populations and control populations.

FIG. 25 depicts a bar graph showing average height of tomato plants in test populations and control populations.

FIG. 26 depicts a bar graph showing average stem diameter of tomato plants in test populations and control populations.

FIG. 27 depicts a bar graph showing average number of fruits per tomato plant in test populations and control populations.

FIG. 28 depicts a bar graph showing average weight of tomato fruits at harvest in test populations and control populations.

FIG. 29 depicts a bar graph showing average length of tomato fruits at harvest in test populations and control populations.

FIG. 30 depicts a bar graph showing average diameter of tomato fruit grown at harvest in test populations and control populations.

FIG. 31 depicts a bar graph showing average Brix degrees of tomato fruit at harvest in test populations and control populations.

FIG. 32 depicts a bar graph showing average percent yield differences between certain test populations and control populations for in-furrow applications.

FIG. 33 depicts a bar graph showing average percent yield differences between certain test populations and control populations for side-dress applications.

FIG. 34 depicts a bar graph showing average percent yield differences between certain test populations and control applications.

### DETAILED DESCRIPTION OF THE INVENTION

### Definitions

While the following terms are believed to be familiar to those of ordinary skill in the art, the following definitions are offered to improve the understanding of the subject matter disclosed herein.

As used herein, the term “a” or “an” encompasses a single entity or more than one of that same entity. The terms “a” or “an” can be used interchangeably with other phrases such as “one or more,” “at least one,” and the like. The use of the indefinite article “a” or “an” does not exclude the possibility that more than one referent is present, unless it is clear from the context that the article “a” or “an” only refers to a single element.

As used herein, the term “agricultural” broadly applies to plants that are cultivated. For example, an “agricultural treatment” is a treatment that is intended to affect a plant. An “agricultural target” refers to a plant or an aspect of the plant's environment such as the soil to which a fertilizer or other beneficial agricultural composition is applied in order to obtain a beneficial or desirable agricultural effect or result. Those beneficial or desirable agricultural effects or results of particular importance to the deliberate cultivation of plants may be termed “agronomic effects,” or “effects of agronomic significance,” and the like. Agronomic effects include, without limitation, beneficial effects or desirable effects or results such as, inter alia, improvement in growth (e.g., improved plant size, increased plant biomass, increased root length or number, improved root architecture, increased shoot length, increased yield (number of seeds, fruits, ears, etc., number of kernels or grains, increased size or weight of seeds, fruits, kernels, or grains, increased number of pods, and the like)), improved metabolism (improved nitrogen and other nutrient availability, uptake and utilization, improved photosynthetic capability, and the like) improved stress tolerance (improved tolerance to abiotic stressors, reduced number of wilted leaves per plant, increased yield under water-limited conditions, resistance to pathogens and pests, and the like) and improvement in plant product composition (altered oil content, altered protein composition, altered carbohydrate composition, altered sugar levels in fruits, and the like).

As used herein, the term “stress” refers to an external condition that adversely affects a plant's reproduction, growth, development, metabolism, yield, or other aspect of plant health. It is understood that stress in a plant can trigger various adaptive responses such as (without limitation) changes in cellular metabolism, growth rates, crop yields, and the like; the adaptive responses to stress can have a deleterious effect on plant health. The term “stress” includes two subtypes of stress, abiotic stress and biotic stress, and combinations of the two. As used herein, the term “abiotic stress” includes those stresses imposed by inanimate (i.e., non-living) aspects of the environment, such as physical or chemical stressors. Abiotic stress can be due to a wide variety of factors, many of which are present in only particular geographic regions and which arise from both major and minor meteorological conditions and changes, whether of shorter or longer duration. Abiotic stressors include, without limitation, heat, cold, exposure to salt-affected soil, drought, soil nutrient deficiencies, radiation such as ultraviolet radiation or nuclear radiation, heavy metal exposure, and the like. Biotic stressors are imposed on plants by living organisms, including (without limitation) microorganisms such as viruses, fungi, or bacteria, and multicellular organisms such as insects, nematodes, arachnids, and competing plants (weeds).

As used herein, the term “microbial composition” refers to a combination of a microbial consortium with at least one other compound, carrier, or composition, which can be inert (as, for example, a liquid carrier in which the consortium is suspended) or active (as for example, a nutrient, a fertilizer, or a pesticide). A “carrier” is understood to be any agriculturally compatible composition, such as water or an aqueous solution, that supports the survival of the microbes and preferably, when added to a microbial consortium, results in a microbial composition which is suitable for administration to crops, for example by spraying.

As used herein, the term “effective amount” refers to an amount that is sufficient to attain a beneficial effect or desired result.

As used herein, the term “desired result” refers generally to an enhancement of a healthy condition or the avoidance of or improvement of a pathological condition. Pathological conditions whose avoidance or improvement produces the desired result can include conditions such as disease states, infections, chemical exposure, drought conditions or lack of adequate water, deleterious effects due to exposure to excess heat or cold, exposure to unfavorable soil conditions such as salt-affected soil, and the like. Healthy conditions whose enhancement produces the desired result can be identified by comparing a state of the treated agricultural target with the state of a control agricultural target, wherein the control agricultural target has been exposed to conditions similar to those for the treated agricultural target, but without receiving the treatment. Desired results comprising the enhancement of healthy conditions can be reflected in general observations regarding plant properties such as increased size, increased yield, increased vigor, increased fertility, improved organoleptic properties, and the like. In embodiments, the desired result can be associated with specific beneficial agronomic effects, in particular those that can be identified by measuring properties of the plant or the plant environment; such beneficial effects can include, without limitation, increased plant stem or leaf size, increased number of fruits, increased number of roots or root density, improved nutrient uptake from the soil, and other improved product properties such as protein content, oil content, seed composition, increased biomass, increased fruit mass, ear weight, kernel mass, kernel number, pod number, shoot length, seed number, seed weight and the like; improved nitrogen utilization, improved nitrogen fixation, improved resistance to nitrogen stress, increased nitrogen utilization efficiency; improved utilization, improved fixation, improved resistance to nutrient stress, or increased utilization efficiency for other nutrients including without limitation phosphate, iron, sodium, calcium, magnesium, and boron; increased abiotic stress tolerance, increased drought tolerance, increased or enhanced water use efficiency; increased photosynthetic rate; improved pathogen resistance, advantageous modifications to plant architecture; and the like.

An effective amount can require more than one administration of the active ingredient. An effective amount can be the amount necessary to treat a certain condition, to ameliorate, reverse, slow, delay or inhibit the condition, or to provide protection against adverse external effects such as abiotic or biotic stresses. An effective amount can be the amount of administered active ingredient necessary to bring about a beneficial effect or desired result in a plant product, such as increased size, increased yield, increased vigor, increased fertility, improved organoleptic properties, and the like, or an effective amount can be the amount of administered active ingredient to improve plant health, growth, or resistance to disease, insect infestation, or weed challenges. An effective amount can be used with respect to a quantity of an active ingredient that is required for obtaining the beneficial effect or desired result relative to the status quo results that exist in an untreated control specimen under similar conditions. As used herein, the term “fertilizer” refers to a compound or composition that excludes living organisms and that is added to plants or soil to improve plant health, growth, and/or yield. Fertilizers can bring about their beneficial agronomic effects or desired result by providing a nutrient to the plant or adding a nutrient to the soil. Fertilizers include organic and inorganic substances; they can be dispensed as liquids, solids, or gels. Fertilizers can be formulated to have timed release or controlled release or triggered release properties whereby they release their active ingredients slowly or in accordance with specific external triggers such as a change in temperature or an exposure to moisture. Organic substances in fertilizers are those that are derived from sources in nature such as manure, compost, blood meal, grub meal, and the like, as opposed to synthetic sources. Inorganic fertilizers are synthetically or artificially produced.

As used herein, the term “formulation” refers to a mixture of ingredients that do not react with each other, including one or more compositions, in specific amounts to produce a substance having desired characteristics or properties.

As used herein, the term “growth” in reference to a plant encompasses a wide variety of improved plant properties that can lead to larger size in the overall plant or increased amount of harvestable plant material or plant products. The properties leading to increased growth in a plant can include, without limitation, improved or increased nitrogen fixation, improved or increased utilization, fixation, resistance to nutrient stress, or utilization efficiency for other nutrients including without limitation phosphate, iron, sodium, calcium, magnesium, and boron; improved or increased photosynthesis; increased leaf or root area, improved seed germination, increased accumulated biomass; and the like.

As used herein, the term “isolated” refers to a microbe that has been separated from at least one of the materials with which it is associated in a particular environment (for example soil, water, plant tissue), through various artificial techniques that remove it from its natural setting and place it into a non-naturally occurring state of existence.

As used herein, the term “macronutrient” refers to nitrogen, phosphorus, and potassium. More generally, the term “nutrient” refers to any compound or composition that is used for plant health, metabolism, growth, reproduction, and the like, including both macronutrients and micronutrients.

As used herein, the term “microbe” includes the two prokaryotic domains, Bacteria and Archaea, while the term “bacterium” or “bacteria” refers to a member of the former prokaryotic domain.

As used herein, the term “microbial consortium” or “microbial consortia” refers to a community of different isolated microbes, which may comprise two or more species or strains of a species of microbes, which have been artificially assembled to achieve one or more beneficial effects or desired results. A consortium can comprise two or more sets of microbes, wherein each set of microbes is included in order to attain a beneficial effect or desired result, such as improved plant health, growth, or product yield, with the beneficial effect or desired result being the same or different for the different sets of microbes. Two or more sets of microbes in the consortium may operate synergistically, i.e., whereby the interaction of the sets of microbes yields a beneficial effect or desired result greater than the sum of their separate effects. Two or more sets of microbes in the consortium may operate cooperatively, with a first set enhancing the effectiveness of the second set or improving its competitive fitness with or without bringing about a beneficial effect or desired result of its own.

As used herein, the term “constitutive isolated microbe” refers to a microbe that is a member of a grouping of microbes from which a member must be included in any microbial consortium in accordance with the present invention. In embodiments, five constitutive isolated microbes have been identified, of which one, two, three, four, or five microbes must be included in a microbial consortium in accordance with the present invention. Those microbes considered “constitutive” are designated herein by the italicized name of the microbe followed by an asterisk (*).

As used herein, the term “plant” refers to those multicellular organisms that are photosynthetic eukaryotic organisms in the kingdom Plantae. Without limitation, the term includes organisms classified as land plants (Embryophyta) and green plants (Viridiplantae), both angiosperms and gymnosperms. Plants can be cultivated, for example to provide food, or as animal feedstock, or for economic or decorative uses. Plants can also be found in natural environments, growing without human intervention. A plant part is an area or anatomical component of a plant.

The term “treatment” or “treat” or the like, as used herein, refers broadly to the use of an agent or intervention such as those disclosed herein, wherein the use of the agent or intervention is intended to obtain the desired beneficial result, whether such result entails an improvement of a current healthy condition or whether it entails an amelioration of an undesirable or unhealthy condition. A treatment can bring about the improvement of a pathological condition or the avoidance of a pathological condition. For example, the treatment can inhibit an undesirable condition, protect against an undesirable condition, prevent the worsening of an undesirable condition, stabilize, reverse, slow or delay the progression of an undesirable condition (such as, without limitation, a disease, a disorder, an infection or infestation, a stress condition, or a predisposition to a disease or disorder). A treatment can effect the enhancement of a healthy condition. A treatment can also obtain a beneficial agronomic effect or desired result relative to the occurrence of such an agronomic effect or desired result that would be found in an untreated control over similar conditions.

As used herein, the term “yield” refers to an amount of harvestable plant material or plant-derived product, which allows the measurement of the economic value of an agricultural crop. The harvested material or plant-derived product varies from crop to crop. For example, it can be seeds, above-ground biomass, roots, fruits, fibers, leaves, flowers, or any other part of the plant or plant product of economic value. Yield can be defined in terms of quantity or quality. For quantitative measurement, yield can be measured as the amount of harvested material per acre or per unit of production.

### Microbial Compositions

Disclosed herein, in embodiments, are microbial compositions comprising a microbial consortium, wherein the combination of isolated microbes in the consortium leads to the composition possessing functional attributes that are not possessed by any one individual member of the consortia when considered alone.

Without being bound by theory, it is understood that isolated microbes in a consortium can act to solubilize potassium in the soil, thereby making this macronutrient more available for plant uptake. Various organic acids such as oxalic acid, tartaric acid, gluconic acid, 2-ketogluconic acid, citric acid, malic acid, succinic acid, lactic acid, propionic acid, glycolic acid, malonic acid, fumaric acid, are effective in releasing K from K-bearing mineral. Tartaric acid, citric acid, succinic acid, α-ketogluconic acid, and oxalic acid are the most prominent acids released by potassium-solubilizing bacteria (KSB). KSB can produce protons (acidolysis mechanism), which are able to convert the insoluble potassium (mica, muscovite, and biotite feldspar) to soluble forms of potassium.

Through these and other mechanisms, certain of the isolated microbes in these consortia can directly increase the potassium available to plants. Complementing the acidolysis mechanism described above, isolated microbes in these consortia can decompose organic materials in the soil, thereby producing ammonia and hydrogen sulfide that can be oxidized in the soil to form strong inorganic acids like nitric acid and sulfuric acid; hydrogen ions from these acids displace K from the cation-exchange complexes in the soil, thereby increasing the available K for plant use.

Isolated microbes in the microbial consortia disclosed herein can further have beneficial effects on general plant growth, by influencing hormone production, nitrogen fixation, phosphorus solubilization, micronutrient solubilization, and root colonization. Moreover, isolated microbes in the microbial consortia disclosed herein can protect plants from undesirable conditions such as biotic and abiotic stress conditions and induce tolerance to biotic and abiotic stresses. It is understood that the isolated microbes in the microbial consortia can further include progeny or mutants of the isolated microbial strains specified below, including progeny resulting from selection for a desired biological activity. It is understood that progeny or mutants of a designated strain can possess biological activity similar to that of the specified strain, and thus can be used for similar agricultural purposes.

In certain embodiments, the composition comprises a microbial consortium that comprises at least one of the following constitutive isolated microbes (constitutive isolated microbes are each indicated by an asterisk herein):

Pseudomonas putida*, for example strain ATCC B-14938

Bacillus mojavensis*

Rhodopseudomonas palustris*, for example strain ATCC 33872

Pseudomonas protegens*

Lactobacillus plantarum*, for example strain ATCC 8014

In embodiments, the composition can comprise at least two, at least three, at least four, or at least five of the constitutive isolated microbes set forth above. In addition to the constitutive isolated microbes set forth above, the composition can, optionally, include one or more of the following non-constitutive isolated microbes:

Paenibacillus durus, for example strain ATCC 85681 or ATCC B-14372

Bacillus firmus, for example strain USDA B-14307

In addition to the foregoing constitutive isolated microbes and the abovementioned non-constitutive isolated microbes, one or more of the following additional optional non-constitutive isolated microbes can be added to the composition, or can be selected to replace one or more of the previous components of the composition, provided that the composition comprises at least one of the constitutive isolated microbes listed above. Such additional optional microbes available for inclusion include:

Pseudomonas fluorescens, for example strain ATCC 50890

Bacillus coagulans, for example strain ATCC 7050

Bacillus amyloliquefaciens, for example strain ATCC B-14395

Bacillus subtilis, for example strain ATCC 10774

Bacillus lichenformis, for example strain ATCC 12759

Bacillus brevis, for example strain ATCC 8246 or ATCC NRS-604

Alicaligenes faecalis

Pseudomonas denitrificans

Burkholderia spp.

Bacillus pumilus

Bacillus cereus

Bacillus megaterium, for example strain ATCC 14581

Bacillus thuringiensis

Without limitation, isolated microbes of the species and strains designated above (and progeny thereof) were selected for the microbial consortium based on certain metabolic or functional properties that are known in the art or that been determined through laboratory testing. These properties can be summarized as follows.

Pseudomonas putida*

Solubilizes potassium to produce a slightly acidic environment (demonstrated by a slightly acidic environment surrounding the bacterial colonies in laboratory testing).

Produces Indole-3-acetic acid (IAA) plant hormone, a trait associated with stimulation of root initiation and elongation.

Produces siderophores, such as pyoverdine and pyochelin.

Produces rhamnolipids (a class of glycolipid that can function as a surfactant).

Produces gibberellins (as known in the art, these hormones produced by plants regulate developmental processes such as stem elongation, germination, seed dormancy, flowering, flower growth, and leaf and fruit senescence).

Can aid in nitrogen fixation within the soil.

Bacillus mojavensis*

Solubilizes potassium to produce a slightly acidic environment (demonstrated by a slightly acidic environment surrounding the bacterial colonies in laboratory testing).

Can solubilize phosphate.

Produces a serine alkaline protease (a proteolytic enzyme).

Produces lipopeptides surfactin and fengycin.

Produces byproducts of saponins (triterpene glycosides), byproducts of bacopasides (triterpene saponins), and byproducts of stigmasterol (phytosterol).

Rhodopseudomonas palustris*

Solubilizes potassium to produce a slightly acidic environment (demonstrated by a slightly acidic environment surrounding the bacterial colonies in laboratory testing).

Can activate phototrophic or chemotrophic pathways, to optimize survivability (i.e., photoautotrophic, photoheterotrophic, chemoautotrophic, or chemoheterotrophic pathways).

Can convert atmospheric CO₂ to biomass.

Pseudomonas protegens*

Solubilizes potassium to produce a slightly acidic environment (demonstrated by the slightly acidic environment surrounding the bacterial colonies in laboratory testing).

Can solubilize phosphate.

Can carry out steps of nitrogen fixation.

Produces ubiquinone.

Produces folate in the rhizosphere.

Lactobacillus plantarum*

Solubilizes potassium to produce a slightly acidic environment (demonstrated by the slightly acidic environment surrounding the bacterial colonies in laboratory testing).

Can solubilize phosphate.

Increases amino acid production in plants.

Produces ubiquinone.

Improves gibberellin production in plants when present in the rhizosphere surrounding them.

Can aid in nitrogen fixation within the soil.

Paenibacillus durus

Solubilizes potassium to produce a slightly acidic environment (demonstrated by the slightly acidic environment surrounding the bacterial colonies in laboratory testing).

Can solubilize phosphate.

Can aid in controlling ethylene levels in plants.

Can aid in nitrogen fixation within the rhizosphere.

Bacillus firmus

Solubilizes potassium to produce a slightly acidic environment (demonstrated by the slightly acidic environment surrounding the bacterial colonies in laboratory testing).

Produces secondary metabolites that can solubilize phosphate.

Generates Indole-3-acetic acid (IAA) (the most common naturally occurring plant hormone of the auxin class).

In some embodiments, an isolated microbe species of the consortium is present in a formulation in an amount effective to be detectable within and/or on an agricultural target, such as a plant or a plant component (a root, a stem, a leaf, etc.) or other plant tissue, or an aspect of a plant's environment such as the soil. For example, an isolated microbe component of the consortium can be detected in an amount of between 1×10³ and 1×10¹⁰ CFU spores, or at least 1,000 CFU or spores, at least 3,000 CFU or spores, at least 10,000 CFU or spores, at least 30,000 CFU or spores, at least 100,000 CFU or spores, at least 300,000 CFU or spores, at least 1,000,000 CFU or spores, or more, in and/or on a target tissue of a plant.

In certain embodiments, the composition of the invention is a fluid composition comprising a microbial consortium as described herein. The concentration (in CFU/mL) of each isolated microbe species in the composition can vary. For example, each isolated microbe species can be present in the composition at a concentration of 1E+02 CFU/mL to 1E+10 CFU/mL, preferably 1E+03 CFU/mL to 1E+08 CFU/mL and more preferably 1E+05 CFU/mL to 1E+07 CFU/mL. In certain embodiments, the concentrations of the isolated microbe species are independent of each other. In other embodiments, the concentrations of the isolated microbe species are substantially the same, for example, within a factor of 5 or 10.

In an embodiment, the composition of the invention is a fluid composition comprising the microbial consortium that can include the following isolated microbe species: Pseudomonas putida, B. mojavensis, Rhodopseudomonas palustris, P. protegens, P. durus, Lactobacillus plantarum, and Bacillus firmus. In embodiments, the fluid composition can comprise the foregoing microbial consortium in the amounts specified in Table 1A (Composition 1A):

TABLE 1A

| Microbial Component-Composition 1A | Concentration of Microbe |
|---|---|
| Pseudomonas putida | 3.15E+05 CFU/mL |
| B. mojavensis | 3.15E+05 CFU/mL |
| Rhodopseudomonas palustris | 3.15E+05 CFU/mL |
| P. protegens | 3.15E+05 CFU/mL |
| P. durus | 3.15E+05 CFU/mL |
| Lactobacillus plantarum | 3.15E+05 CFU/mL |
| Bacillus firmus | 3.15E+05 CFU/mL |
| Total CFU/mL | 2.21E+06 CFU/mL |

A concentrated version of Composition 1A can comprise the foregoing microbial consortium in the amounts specified in Table 1B (Composition 1B)

TABLE 1B

| Microbial Component-Composition 1B | Concentration of Microbe |
|---|---|
| Pseudomonas putida | 6.30E+06 CFU/mL |
| B. mojavensis | 6.30E+06 CFU/mL |
| Rhodopseudomonas palustris | 6.30E+06 CFU/mL |
| P. protegens | 6.30E+06 CFU/mL |
| P. durus | 6.30E+06 CFU/mL |
| Lactobacillus plantarum | 6.30E+06 CFU/mL |
| Bacillus firmus | 6.30E+06 CFU/mL |
| Total CFU/mL | 4.4E+07 CFU/mL |

In another embodiment, the composition of the invention is a fluid composition comprising the microbial consortium that can include the following isolated microbe species: Pseudomonas putida, Bacillus mojavensis, Rhodopseudomonas palustris, Pseudomonas protegens, Bacillus amyloliquefaciens, Bacillus subtilis, and Bacillus licheniformis. In embodiments, the fluid composition can comprise the foregoing microbial consortium in the amounts specified in Table 2A (Composition 2A):

TABLE 2A

| Microbial Components-Composition 2A | Concentration of Microbe |
|---|---|
| Pseudomonas putida | 3.15E+05 CFU/mL |
| Bacillus mojavensis | 3.15E+05 CFU/mL |
| Rhodopseudomonas palustris | 3.15E+05 CFU/mL |
| Pseudomonas protegens | 3.15E+05 CFU/mL |
| Bacillus amyloliquefaciens | 3.15E+05 CFU/mL |
| Bacillus subtilis | 3.15E+05 CFU/mL |
| Bacillus licheniformis | 3.15E+05 CFU/mL |
| Total CFU/mL | 2.21E+06 CFU/mL |

A concentrated version of Composition 2A can comprise the foregoing microbial consortium in the amounts specified in Table 21B (Composition 21B).

TABLE 2B

| Microbial Component-Composition 2B | Concentration of Microbe |
|---|---|
| Pseudomonas putida | 6.30E+06 CFU/mL |
| Bacillus mojavensis | 6.30E+06 CFU/mL |
| Rhodopseudomonas palustris | 6.30E+06 CFU/mL |
| Pseudomonas protegens | 6.30E+06 CFU/mL |
| Bacillus amyloliquefaciens | 6.30E+06 CFU/mL |
| Bacillus subtilis | 6.30E+06 CFU/mL |
| Bacillus licheniformis | 6.30E+06 CFU/mL |
| Total CFU/mL | 4.4E+07 CFU/mL |

In embodiments, the microbial consortium in a composition is suspended in an aqueous fluid, which can comprise a strong or weak acid, such as water with citric acid, with citric acid added in amounts from about 0.5 gm/L to about 2 gm/L. In other embodiments, the composition can be prepared in a concentrated form, which is then diluted by the end user prior to application. The concentration of a given bacterial species in the diluted composition is calculated using the following equation:

M1V1=M2V2 EQ1:

where M1 is the concentration of the bacterial species in the concentrated composition, V1 is the volume of the concentrated composition, M2 is the concentration of the bacterial species in the diluted composition, and V2 is the volume of the diluted composition.

Species of bacteria for inclusion in the foregoing consortia were validated by sequence comparison of the 16S gene region of each species, vs those known bacteria in the National Center for Biotechnology Information (NCBI) BLAST database, using the BLAST: Basic Local Alignment Search Tool (nih.gov) tool. A 90%-95% identity between the test species and the reference species in the 16S gene region was used to confirm the bacterium species. Table 3 displays the bacteria used in certain consortia of the invention and their percent of 16S gene matching vs the reference bacteria in the NCBI BLAST database.

TABLE 3

| | % Identity | Genome | |
|---|---|---|---|
| | (16S) | Sequenced | Reference Genome |
| Pseudomonas putida | 99.57 | Yes | Pseudomonas putida |
| | | | NBRC 14164, |
| | | | complete genome |
| B mojavensis | 99.45 | Yes | Bacillus mojavensis |
| | | | strain UCMB5075 |
| | | | chromosome, |
| | | | complete genome |
| Rhodopseudomonas | 97.33 | Yes | Rhodopseudomonas |
| palustris | | | palustris BisB18 |
| P protegens | 99.47 | Yes | Pseudomonas |
| | | | protegens CHA0 |
| | | | chromosome 1 |
| P durus | 98.29 | Yes | Paenibacillus durus |
| | | | strain DSM 1735 |
| | | | chromosome, |
| | | | complete genome |
| Lactobacillus | 99.78 | Yes | Lactobacillus |
| plantarum | | | plantarum subsp. |
| | | | argentoratensis strain |
| | | | DSM 16365 |
| Bacillus firmus | 99.89 | Yes | Cytobacillus firmus |
| | | | strain NCTC10335, |
| | | | whole genome |
| | | | shotgun sequence |

In some aspects, samples of isolated microbes for the consortia can be obtained from the USDA and/or ATCC collection database. The isolation and culturing of the microbes disclosed herein can be affected using standard microbiological techniques, as would be familiar to artisans of ordinary skill. Examples of such techniques may be found in Gerhardt, P. (ed.) Methods for General and Molecular Microbiology. American Society for Microbiology, Washington, D.C. (1994) and Lennette, E. H. (ed.) Manual of Clinical Microbiology, Third Edition. American Society for Microbiology, Washington, D.C. (1980), each of which is incorporated by reference.

In embodiments, isolation can be effected by streaking the specimen on a solid medium (e.g., nutrient agar plates) to obtain a single colony, which is characterized by the phenotypic traits described hereinabove (e.g., Gram positive/negative, capable of forming spores aerobically/anaerobically, cellular morphology, carbon source metabolism, acid/base production, enzyme secretion, metabolic secretions, etc.) and to reduce the likelihood of working with a culture which has become contaminated. For example, for isolated bacteria of the disclosure, biologically pure isolates can be obtained through repeated subculture of biological samples, each subculture followed by streaking onto solid media to obtain individual colonies. Methods of preparing, thawing, and growing lyophilized bacteria are commonly known, for example, Gherna, R. L. and C. A. Reddy. 2007. Culture Preservation, p 1019-1033. In C. A. Reddy, T. J. Beveridge, J. A. Breznak, G. A. Marzluf, T. M. Schmidt, and L. R. Snyder, eds. American Society for Microbiology, Washington, D.C., 1033 pages; herein incorporated by reference. Thus, freeze dried liquid formulations and cultures stored long term at −70C° in solutions containing glycerol are contemplated for use in providing formulations as disclosed herein.

In embodiments, the bacteria of the disclosure can be propagated in a liquid medium under aerobic conditions. Media for growing the bacterial strains of the present disclosure includes a carbon source, a nitrogen source, and inorganic salts, as well as specially required substances such as vitamins, amino acids, nucleic acids and the like. Examples of suitable carbon sources which can be used for growing the bacterial strains include, but are not limited to, starch, peptone, yeast extract, amino acids, sugars such as glucose, arabinose, mannose, glucosamine, maltose, and the like; salts of organic acids such as acetic acid, fumaric acid, adipic acid, propionic acid, citric acid, gluconic acid, malic acid, pyruvic acid, malonic acid and the like; alcohols such as ethanol and glycerol and the like; oil or fat such as soybean oil, rice bran oil, olive oil, corn oil, sesame oil. The amount of the carbon source added varies according to the kind of carbon source and is typically between 1 to 100 gram(s) per liter of medium. Preferably, glucose, starch, and/or peptone is contained in the medium as a major carbon source, at a concentration of 0.1-5% (W/V). Examples of suitable nitrogen sources which can be used for growing the bacterial strains of the present invention include, but are not limited to, amino acids, yeast extract, tryptone, beef extract, peptone, potassium nitrate, ammonium nitrate, ammonium chloride, ammonium sulfate, ammonium phosphate, ammonia or combinations thereof. The amount of nitrogen source varies according to the type of nitrogen source, typically between 0.1 to 30 gram per liter of medium. The inorganic salts, potassium dihydrogen phosphate, dipotassium hydrogen phosphate, disodium hydrogen phosphate, magnesium sulfate, magnesium chloride, ferric sulfate, ferrous sulfate, ferric chloride, ferrous chloride, manganous sulfate, manganous chloride, zinc sulfate, zinc chloride, cupric sulfate, calcium chloride, sodium chloride, calcium carbonate, sodium carbonate can be used alone or in combination. The amount of inorganic acid varies according to the kind of the inorganic salt, typically between 0.001 to 10 gram per liter of medium. Examples of specially required substances include, but are not limited to, vitamins, nucleic acids, yeast extract, peptone, meat extract, malt extract, dried yeast and combinations thereof. Cultivation can be effected at a temperature, which allows the growth of the bacterial strains, essentially, between 20C° and 46C°. In some aspects, a temperature range is 30C°-37C°. For optimal growth, in some embodiments, the medium can be adjusted to pH 7.0-7.4. It will be appreciated that commercially available media may also be used to culture the bacterial strains, such as Nutrient Broth or Nutrient Agar available from Difco, Detroit, Mich. It will be appreciated that cultivation time may differ depending on the type of culture medium used and the concentration of sugar as a major carbon source. In aspects, cultivation lasts between 24-96 hours.

Bacterial cells thus obtained are isolated using methods, which are well known in the art. Examples include, but are not limited to, membrane filtration and centrifugal separation. The pH may be adjusted using sodium hydroxide and the like and the culture may be dried using a freeze dryer, until the water content becomes equal to 4% or less. Microbial co-cultures may be obtained by propagating each strain as described hereinabove. It will be appreciated that the microbial strains may be cultured together when compatible culture conditions can be employed.

In embodiments, a method of growing microbes for use in the formulations disclosed herein comprises the following steps, with each species of microbe being grown individually as a pure culture; no mixed cultures are grown to be used in the microbial consortium. The steps listed below are desirably performed in an aseptic environment inside a biological safety cabinet.

For each pure microbe strain, TSA/LB/Nutrient agar plates are prepared using LB broth, TSA agar and PBS, and autoclaved at 121° C. for 30 minutes.

For each strain, 1 μl of the frozen microbe stock is streaked out on the TSA/LB/Nutrient Agar plate by using an inoculating loop, and the plate is incubated at 30° C. for 48 hrs.

After the incubation period, specimens from each microbial colony are inoculated into 50-75 mL of LB broth using a 1 μl inoculating loop. The cultures thus prepared for each strain are incubated at 32° C., 175 rpm during 48 hrs. on a platform shaker.

After this incubation period, specimens from the first pre-culture are inoculated into 2-3 L of LB broth (1/1000→4 mL), following which each culture is incubated at 32° C., 150 rpm during 48 hrs. on a platform shaker.

Once the bacteria have achieved their stationary phase, they are checked for contaminants through a gram stain and streak plate. If no contaminants are discovered, then the bacteria are aseptically transferred to a sterile 150-Liter bioreactor through autoclaved addition vessels, wherein all ingredients and liquids are steam sterilized to 121° C. at 15 psi for 50 minutes. The bacteria are then allowed to culture at 37° C. for 36 hours in airtight containment with pH and dissolved oxygen (DO) sensor modulations.

Once the bacteria cultures achieve stationary phase, they are quality control checked, with tests that can include Gram staining, isolation streak plating, cell count plate (CFU/ml), samples sent for 16S sequencing (it being understood that 16S rRNA sequences can be used for making distinctions between species) and the like. At the completion of these procedures, the bioreactor is shut down appropriately, and the bacterial cells are centrifuged at 24,000 rpm (17,000×G) to separate all the cells from the growth media. The resulting bacterial paste is a pellet that has little to no residual growth media.

The pellet is washed with a 1× saline solution and its pH is adjusted to a value of pH 4.00±0.2. A specific percentage of concentrated pure bacteria paste can be added in order to achieve a final concentration of 3.15×10\hat{ }5 CFU/mL to each container. The following equation can be used to calculate the amount of cell paste needed:

M1V1=M2V2 EQ2:

where: M1=concentration of cell paste, V1=volume of concentrated cell paste needed, M2=final concentration (product concentration), V2=final volume.

Compositions, Formulations, and Methods of their Use

Compositions comprising the microbial consortia disclosed herein can be used to prepare formulations for agricultural treatments. In embodiments, the agricultural compositions of the disclosure can be included in formulations such as: (1) solutions; (2) wettable powders; (3) dusting powders; (4) soluble powders; (5) emulsions or suspension concentrates; (6) seed dressings; (7) tablets; (8) water-dispersible granules; (9) water soluble granules (slow or fast release); (10) microencapsulated granules or suspensions; and (11) irrigation components, and the like. In certain aspects, the compositions may be diluted in an aqueous medium prior to conventional spray application. In embodiments, the formulations comprising the microbial consortia as disclosed herein can be applied to the soil, plant, seed, rhizosphere, rhizosheath, or other areas or plant parts that would be apparent to those of ordinary skill in the agricultural arts. Formulations comprising the compositions disclosed herein, can be applied to a plant, seedling, cutting, propagule, or the like, and/or to the growth media (including hydroponic growth media) supporting such plant, and/or to hydroponic systems for agricultural purposes, using any application technique known in the art. For example, the formulations can be applied to the plant, seedling, cutting, propagule, or the like by spraying or dusting, or similarly applied to the growth media supporting such plant. As another example, the formulations can be applied directly to a plant seed prior to sowing, e.g., as a seed coating. Formulations can be applied to the soil before planting, at the time of planting, after planting during the life cycle or growth cycle of a plant, at the time when fruits are seen, or at any other time when it is anticipated that nutrient requirements may change. In embodiments, formulations can be applied to agricultural targets such as seeds, plants, plant parts, or growth media, including hydroponic growth media, using techniques such as coating the agricultural target with the formulation, spraying or dusting the agricultural target with the formulation, drenching the formulation onto the agricultural target, spreading the formulation onto the agricultural target, broadcasting the formulation onto the agricultural target, preparing the growth media by exposing it to the formulation prior to or during the time of planting, incorporating the formulation in the growth media, or combining the formulation or the microbial consortium it comprises with a fertilizer or other agricultural composition. In embodiments, the microbes in the microbial composition can grow on the surface of roots, stems, leaves or reproductive plant parts, or infiltrate parts of the plant such as the roots, stems, leaves or reproductive plant parts, and/or grow in the plant rhizosphere. In embodiments, the microorganisms can form a symbiotic relationship with the plant.

In more detail, a formulation can comprise a microbial composition and an agriculturally compatible carrier, with optional agriculturally compatible excipients, additives or auxiliary substances (collectively, “additives”), including without limitation, preservatives, surfactants, emulsifiers, stabilizers, buffers, acidifiers or alkalinizing agents, nutrients, thickening agents, gelling agents, dispersants, antifreeze agents, dyes, colorants, pesticides, herbicides, insecticides, fungicides, antibacterial agents, and the like. The optional additives can, in embodiments, act to improve the activity of the microbial compositions, enhance their performance or duration of action, provide resistance against unfavorable environmental conditions, or provide other advantages. In embodiments, the additive can be an adjuvant that acts as a modifier, an activator, a fertilizer, a pesticide, a pH buffer, or the like. In embodiments, the additive can be a pesticide, a plant growth regulator, a biologically active agent, or other beneficial additive.

In exemplary embodiments, the compositions disclosed herein can be formulated as a liquid, powder, or the like for administering to a plant or growth medium as a topical application or drench application. Fluid formulations such as liquids, emulsions, suspensions, concentrates, and the like, can be used for foliar sprays or other liquid applications, for example to treat growing plants or growth media. Solid or liquid formulations can be injected directly into foliar, stem, or root tissue, or inserted into an embryo, a radicle, or coleoptile.

Liquid formulations can include other compounds or salts such as sodium or potassium sulfate or ammonium hydrogen sulfate or ammonium thiosulfate; sodium or potassium or ammonium chloride; sodium or ammonium acetate; ammonium formate, oxalate, carbonate, hydrogen carbonate, hydrogen diphosphate, dihydrogen monophosphate, thiocyanate, sulfamate, or carbamate; ammonium sodium hydrogen phosphate; and the like. In embodiments, a liquid formulation comprises an organic acid (e.g., citric acid) or salts thereof. In embodiments, a liquid formulation can comprise citric acid with water as the carrier.

Formulations employed as seed coatings can include materials such as adhesives or binders that improve the attachment of the formulation to the seed. Such materials can be natural or synthetic, but without phytotoxic effect on the seed to be coated. Binders can include substances such as polyvinyl acetates and copolymers thereof, polyvinyl alcohols and copolymers thereof, celluloses (including without limitation ethylcelluloses, methylcelluloses, hydroxymethylcelluloses, hydroxypropycelluloses and carboxymethylcellulose), ethylene vinyl acetate (EVA) copolymers, polyethylene oxide, polychloroprene; polyvinylpyrolidones, vinylidene chloride and vinylidene chloride copolymers, acrylic copolymers, polyvinylacrylates, polyhydroxyethyl acrylate, methylacrylamide monomers, acrylamide polymers and copolymers; polysaccharides (including starch, modified starch, dextrins, maltodextrins, alginate and chitosans); fats; oils; proteins, including gelatin and zeins; gum arabics; shellacs; and the like. Additional materials such as antifoaming agents can be incorporated in the formulations, as would be understood by skilled artisans in the field.

In exemplary embodiments, the compositions disclosed herein can be formulated as solids. Solid formulations can include vehicles that help provide a matrix for conveying the composition. Materials useful as vehicles can include, alone or in combination, minerals such as silicas, silicates, silica gels, clays, attaclay, kaolin, dolomite, chalk, talc, limestone, loess, diatomaceous earth, montmorillonites, attapulgites, mica, vermiculites, synthetic silicas and silicates calcium sulfate, magnesium sulfate, magnesium oxide, and the like; fertilizers such as ammonium sulfate, ammonium phosphate, ammonium nitrate, thiourea, urea and the like; and products of vegetable origin such as cellulose, cellulose powders, wood meal, nutshell meal, tree bark meal, cereal meals, and the like. Solid formulations can further include binders such as polyvinylpyrrolidone, polyvinyl alcohol, polyvinyl acetate, carboxymethylcellulose, starches, and the like, and combinations or copolymers thereof, lubricants such as magnesium stearate, sodium stearate, talc polyethylene glycol, and the like, or combinations thereof, antifoaming agents such as acetylene diols, fatty acids or organofluorine compounds, silicone emulsions, long-chain alcohols, phosphoric esters, and the like, and combinations thereof. Solid formulations are useful for inserting the composition into the soil, and they can be formed as granules or powders or plugs to be mixed into the soil before or after or alongside planting.

### Applications

Advantageously, in embodiments, the composition comprising the microbial consortia disclosed herein can be administered to a designated agricultural target in an effective amount to bring about an increased level of potassium within plant tissue below and above ground, which can result in a desired result such as the enhancement of a healthy condition or the avoidance of or mitigation of an unhealthy condition, or a beneficial agronomic effect emanating from the enhancement of a healthy condition, such as increased growth; increased yield; improved vigor, leaf and shoot health and growth; improved product properties such as protein content, oil content, seed composition, increased biomass, increased fruit mass, ear weight, kernel mass, kernel number, pod number, shoot length, seed number, seed weight and the like; improved nitrogen utilization, improved nitrogen fixation, improved resistance to nitrogen stress, increased nitrogen utilization efficiency; improved or increased utilization, fixation, resistance to nutrient stress, or utilization efficiency for other nutrients including without limitation phosphate, iron, sodium, calcium, magnesium, and boron; increased abiotic stress tolerance increased or enhanced water use efficiency, increased drought tolerance; increased photosynthetic rate; improved pathogen resistance; advantageous modifications to plant architecture, and the like.

An especially advantageous use of the compositions disclosed herein relates to their effect on increasing abiotic stress tolerance to those conditions that can be associated with alterations in the physical or chemical environment, for example as a result of meteorological conditions, changes or patterns. Another especially advantageous use of the compositions disclosed herein relates to enabling the use as arable land of otherwise marginal farmlands adversely affected by abiotic stress conditions, which can address losses of arable land due to population growth and provide economic opportunities for cultivation of otherwise marginal farmland. Apart from static soil conditions associated with abiotic stress, a variety of factors can induce abiotic stresses, such as (without limitation), temperature changes, increased heat exposure, increased amounts of salts in soils due to irrigation practices, increased evaporation (with such salt-affected soils including saline soils, sodic soils, and saline-sodic soils), and drought conditions and lack of irrigation water due to decreased rainfall, impaired watershed availability due to altered water runoff, depleted water table levels, increased evaporation and loss of water retention properties of soil due to loss of organic matter and other soil depletion. As used herein, the term “salt affected” refers to soils in which the concentration of soluble salts in the soil, where such salts can include sodium, calcium, and magnesium cations, and chloride, sulfate and carbonate anions.

Drought conditions represent important examples of the potential beneficial agronomic effects of the compositions disclosed herein. These conditions result in a lack of sufficient moisture for plants to grow and develop in a healthy way, affecting their physical, biochemical, and molecular status, with effects on parameters of plant health such as growth rate and growth patterns, biomass, and yield. Moreover, drought affects soil conditions and levels of soil nutrients, because water serves as a carrier for transporting nutrients (including macronutrients and micronutrients) to plant roots. Additionally, drought can exacerbate other abiotic effects of on soil salinity because it depletes the water in the soil that can dilute or remove salt that otherwise might affect plants. Plants are classified as either glycophytes (which cannot tolerate excessive salinity and ultimately die if the soil salt levels are too high) or halophytes (which can tolerate salinity and can grow in saline soil. The majority of crop plants are glycophytes, whose growth has been observed to decrease or completely cease under soil salt conditions of approximately 100-200 mM NaCl, while halophytes can withstand much higher salt levels. The administration of the microbial consortia disclosed herein to a designated agricultural target experiencing drought conditions in an effective amount to bring about an increased level of potassium plant tissue below and above ground can result in a desired beneficial agronomic effect of improving the agricultural target's resistance to drought conditions, including improving those conditions that result from a lack of sufficient moisture for the plant to grow and develop in a healthy way and those conditions (such as increased salinity) that can be attributed to drought conditions.

Other beneficial agronomic effects that can result from the increased level of potassium within plant tissue above and below ground can include, without limitation, improved general disease resistance, improved hot or cold tolerance, delayed senescence, tolerance to other adverse chemical exposures such as salts, metals, herbicides, and other chemical agents.

In embodiments, the compositions disclosed herein can increase potassium levels in the plant roots, above-ground plant parts such as stems or leaves, and fruits or other agricultural products, in turn producing increased yield or increased growth in a plant. In embodiments, the combination of microbial isolates in the microbial consortia as disclosed herein can produce an agronomic effect or result that is not produced by any one individual member of the consortium. In embodiments, the combination of microbial isolates in the microbial consortia as disclosed herein produces an agronomic effect or result that is not possessed by any one individual member of the consortium. In embodiments, the combination of microbial isolates as disclosed herein produces a synergistic agronomic effect or result, that is, one that produces a total effect or result that is greater than the sum of the contributions of the individual microbes in the consortium. This can be manifested in any plant tissue, including such agronomic effects as larger size in the treated plants, more roots, increased nutrient levels, and the like.

In embodiments, the compositions and formulations disclosed herein can be applied in combination with other agriculturally active ingredients that are used for agricultural treatments; the other agriculturally active ingredients used in combination with the compositions and formulations disclosed herein are termed “secondary treatments.” In such embodiments, compositions and formulations comprising the microbial consortia of the present invention can be applied to the agricultural target in conjunction with the application of another agricultural treatment (a secondary treatment). For example, a microbial consortium as disclosed herein can be applied as part of a treatment protocol that also includes the application of a fertilizer, a pesticide, one or more additional microbes or fungi, or a biocide. The secondary treatment (e.g., the fertilizer, pesticide, biocide, or the like) can be applied at a separate time, or in a separate place, or in a separate manner from the application of the microbial consortium (i.e., the two can be applied separately), or the two agents can be mixed together to be applied together as a combination treatment. Combination treatments can allow the desired result or beneficial agronomic effect of one or both treatment agents to be improved, or can reduce the amount of the secondary treatment that is necessary to achieve the desired result or beneficial agronomic effect for one or both of the treatments. The application of a combination of the compositions and formulations disclosed herein as a primary treatment together with a secondary treatment can allow each treatment (i.e., both the primary and the secondary treatment) to achieve its intended desired result or beneficial agronomic effect without one treatment impacting the other; such a combination can be administered simply for convenience: those desired results or beneficial agronomic effects achieved due to the administration of the secondary treatment can be termed “secondary” in this context. Advantageously, combination treatments can allow a synergy in which the combination of the microbial consortia as disclosed herein with one or more secondary treatment agents increases the desired result or the beneficial agronomic effect produced by one treatment agent or both treatment agents, such outcomes being termed “synergistic effects.” For example, the use of the microbial consortium in keeping with the methods of the present invention can reduce the need for fertilizer use, or can lead to more pronounced beneficial effects from fertilizer use as compared to fertilizer applications that are not combined with the use of the microbial consortia disclosed herein. Either outcome of such combinations (the reduced need for fertilizer or the more pronounced benefits from fertilizer use) can reflect the synergy between the microbial consortia disclosed herein and a fertilizer application.

The impact of combination treatment is especially apparent when the microbial consortia of the present invention are applied in combination with a fertilizer. Any fertilizer that improves the growth of crop or non-crop plants when added to soil may be used in combination with the compositions and methods of the invention. Suitable fertilizers are known in the art. The fertilizer contains plant nutrients, especially nitrogen, phosphorous, or potassium, or any combination thereof, and provides a fertilizing effective quantity of the nutrients when the composition can be applied to soil in combination with the application of microbial consortia as disclosed herein. In embodiments, the application of a fertilizer in combination with the microbial consortia will result in a synergistic effect.

One or more nutrients can be found in fertilizers, including without limitation single nutrients such as potassium, phosphorus, nitrogen, and the like, and combinations of such nutrients. Combinations of nutrients in fertilizers include nitrogen and phosphorous, nitrogen and potassium, phosphorous and potassium, and nitrogen, phosphorous, and potassium. Nitrogen may be provided by an inorganic fertilizer or an organic fertilizer. Suitable inorganic fertilizers and organic fertilizers are known in the art. Inorganic fertilizers may, for example, be selected from the group consisting of ammonia, ammonium nitrate, ammonium sulfate, sodium nitrate, potassium nitrate, urea, and a urea-formaldehyde condensation product such as ureaform (UF). Ureaform consists of short polymeric chains ranging in length from methylene-diurea to tetramethylenepentaurea. The rate of nitrogen release is mainly related to chain solubility. The mineralization of UF is governed by microbial activity, making such products useful for combining with the microbial consortia discussed herein. Organic fertilizers are or contain organic compounds having one or more of nitrogen, phosphorous, or potassium atoms. Suitable fertilizers that provide effective amounts of nitrogen are known in the art. Some examples of such fertilizers are selected from the group consisting of cornmeal, blood meal, red blood cells, cottonseed meal, ocean kelp meal, fish fertilizer, feather meal, soy meal, shrimp and crab meal, cheese and milk whey, algae, biosolids, manure-based composts, landscape and yard-based composts, animal cells and proteins, yeast proteins, food waste proteins, single cell proteins, guano, green manures, alfalfa, leather meal, bone meal and cocoa meal.

Suitable fertilizers that provide effective amounts of phosphorous are known in the art. Some examples of such fertilizers are compounds selected from the group consisting of CaHPO₄, Ca(H₂PO₄)₂, ammonium phosphate, sodium nitrophosphate, potassium nitrophosphate, sodium mono-orthophosphate and potassium mono-orthophosphate. In embodiments, Ca(H₂PO₄)₂ may be a superphosphate, e.g., a mono-superphosphate or a triple superphosphate. Mono-superphosphate is made by reacting concentrated sulfuric acid and phosphate rock. Triple-superphosphate is made by reacting phosphoric acid and phosphate rock. Suitable fertilizers that provide effective amounts of potassium are known in the art. Some examples of such fertilizers are selected from the group consisting of potash, potassium chloride, carnallite, potassium sulfate, and potassium nitrate.

Additional microbes and/or fungi which can be used in combination with the microbial consortium of the invention include those microbes and fungi which are known to have effects which are different from, or complementary to, those of the microbial consortium. Suitable such microbes and fungi include, but are not limited to, mycorrhizal fungi and Trichoderma.

While the foregoing description is provided to exemplify some of the combinations of microbial consortia and other agricultural treatment agents that can be arranged, it is understood that a wide range of other combinations that fall within the scope of the present invention can be envisioned by skilled artisans using no more than routine experimentation.

### EXAMPLES

### Example 1: Testing Isolated Microbes and Microbial Consortia for Solubilizing Potassium

Methods for preparing the microbial consortia described in this Example are modified from those methods set forth in the following reference, the contents of which are included herein by reference in entirety: Mahendra Vikram Singh RAJAWAT, Surender SINGH, Satya Prakash TYAGI, Anil Kumar SAXENA, A Modified Plate Assay for Rapid Screening of Potassium-Solubilizing Bacteria, Pedosphere, Volume 26, Issue 5, 2016, Pages 768-773, ISSN 1002-0160, https://doi.org/10.1016/S1002-0160(15)60080-7.

The bacteria for this Example, as listed in Table 4 below, were grown in the appropriate liquid media Tryptic Soy, Luria Broth or Nutrient broth for 24 h-72 h hours. The liquid culture was then spun down at 13000 rpm and the supernatant discarded. The pellet was then washed with 1% Saline and the centrifuge process was repeated 3 times with 1% saline. After the final wash the cells were resuspended for testing.

A total of 20 bacterial isolates were purified and 10 μl spot-inoculated on Aleksandrov agar medium plates. The plates were incubated for 7 to 14 days at 30° C. and observed for the formation of halo zones around the colonies. Cultures positive for K solubilization based on plate assay were grown in Aleksandrov broth individually. All chemicals used were of analytical grade. The results are shown in Table 4. A positive test, indicated by a + sign, was confirmed by halo or zone of clearing on the agar plates.

TABLE 4

| | | Aleksandrov | |
|---|---|---|---|
| Analysis | Received As | medium | Avg CFU/mL |
| Sample ID | Liquid pure culture | + | CFU/mL |
| Bacillus mojavensis | | | 3.15 × 10⁵ |
| Sample ID | Liquid pure culture | + | CFU/mL |
| Pseudomonas | | | 3.15 × 10⁵ |
| protegens | | | |
| Sample ID | Liquid pure culture | + | CFU/mL |
| Pseudomonas | | | 3.15 × 10⁵ |
| putida | | | |
| Sample ID | Liquid pure culture | + | CFU/mL |
| Pseudomonas | | | 3.15 × 10⁵ |
| palustris | | | |
| Sample ID | Liquid pure culture | + | CFU/mL |
| Paenibacillus | | | 3.15 × 10⁵ |
| durus | | | |
| Sample ID | Liquid pure culture | + | CFU/mL |
| Lactobacillus | | | 3.15 × 10⁵ |
| plantarum | | | |
| Sample ID | Liquid pure culture | + | CFU/mL |
| Bacillus firmus | | | 3.15 × 10⁵ |
| Sample ID | Liquid mixed | + | CFU/mL |
| Composition 1A | culture | | 3.15 × 10⁵ |
| (from Table 1A) | | | |

Qualitative analysis of K solubilization was carried out using the Aleksandrov medium (pH 7.2±0.2) containing 5.0 g L⁻¹ glucose, 0.5 g L⁻¹ magnesium sulphate, 0.005 g L⁻¹ ferric chloride, 0.1 g L⁻¹ calcium carbonate, 2 g L⁻¹ calcium phosphate, and 2 g L⁻¹ K-bearing minerals (Hu et al., 2006). Potassium aluminosilicates were purchased from HiMedia Labs. All chemicals used were of analytical grade.

To prepare the Aleksandrov medium for testing, a stock dye solution was mixed in 100 mL of Aleksandrov agar medium to achieve final concentrations of 100.0 mg/L. After adding the measured amount of dye solution, the medium was autoclaved and poured into Petri plates. Plates containing Aleksandrov medium without dye solution served as a control. The halo zone size and colony diameter were measured after 7 and 14 days. The halo zone size was calculated by subtracting the diameter of colony from the total diameter.

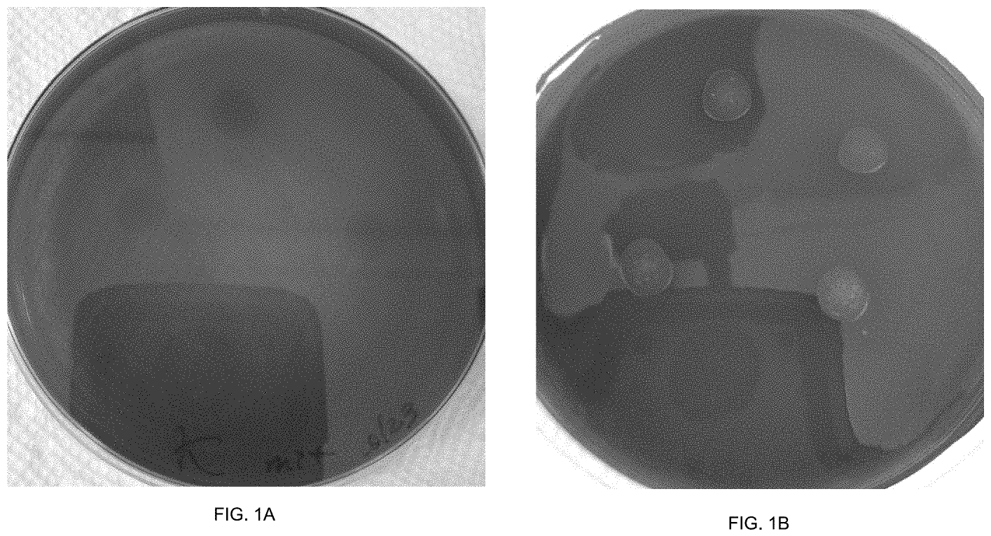

The qualitative results of the Aleksandrov medium tests are exemplified by the images shown in FIGS. 1A and 1B. In FIG. 1A, a microbial consortium as disclosed herein has been allowed to grow for 7 days at 30° C. The secondary metabolites have turned the surrounding agar slightly acidic. In FIG. 1B, the same microbial consortium has been allowed to grow for 14 days at 30° C. The agar surface is more alkaline, as indicated by the blue color on the agar plates.

### Example 2: Testing Isolated Microbes and Microbial Consortia for Solubilizing Phosphate

The bacteria for testing were grown in the appropriate liquid media (Tryptic Soy, Luria Broth or Nutrient broth) for 24 h-72 h hours. The liquid culture was then spun down at 13000 rpm and the supernatant discarded. The pellet was then washed with 1% Saline and the centrifuge process was repeated 3 times with 1% saline. After the final wash the cells were resuspended for testing, producing samples that contained the isolated microbes set forth in Table 5 below and the microbial consortium disclosed in Table 1A above.

Qualitative assays of phosphate solubilization were modified from those methods described in Manoharan Melvin Joe, Shalini Deivaraj, Abitha Benson, Allen John Henry, G. Narendrakumar, Soil extract calcium phosphate media for screening of phosphate-solubilizing bacteria, Agriculture and Natural Resources, Volume 52, Issue 3, 2018, Pages 305-308, ISSN 2452-316X, https://doi.org/10.1016/j.anres.2018.09.014, the contents of which are incorporated by reference in their entirety.

SECP broth was used for the testing. The SECP broth contained the following components: dextrose 5.0 g/L, CaCl₂) 5.0 7 g/L, KH2PO4 0.0584 g/L, K2HPO4 0.1547 g/L and 200 mL of soil extract. The final volume of the medium was made to 1 L, and the pH was adjusted to 7.0. The available nitrogen, phosphorous and potash contents and the organic carbon of the soil used in the experimental study was 106.4 mg/kg, 8.6 mg/kg, 159.6 mg/kg and 0.32%, respectively. The soil extract was prepared by dissolving 200 g of soil in 1,000 mL of distilled water, followed by autoclaving at 105° C. (twice followed by cooling). The contents were cooled and filtered using Whatman No 44 filter paper.

For halo zone detection for phosphate solubilization, 14 g/L of soil extract was added to the SECP solid medium, with the PVK solid medium used for comparative purposes. Phosphate solubilization was observed based on the clear zone using 100 μL of bromothymol 8 blue (0.4%). For comparative plate assay, different microbes as set forth in Table 5 were point inoculated (10 μL) using a micropipette onto SECP agar before being supplemented with calcium phosphate/rock phosphate for the screening. For point inoculation, 24 h grown bacterial cultures were pelleted by centrifuging at 5000×g, and the pellets were dissolved in PBS with necessary adjustments made to attain an inoculation load of 3.15×10⁵ cfu/mL. The plates were incubated at 28° C., for 7 to 14 d. Halo zone size was determined by subtracting the total zone diameter from the colony diameter as described earlier.

Results of these tests are set forth in Table 5 below. A positive test, indicated by a + sign, was confirmed by halo or zone of clearing on the agar plates.

TABLE 5

| | | | Soil extract | |
|---|---|---|---|---|
| | | Pikovskaya | calcium | |
| | | (PVK) | phosphate | Avg |
| Analysis | Received As | medium | (SECP) | CFU/mL |
| Sample ID | Liquid pure | + | + | CFU/mL |
| Bacillus | culture | | | 3.15 × 10⁵ |
| mojavensis | | | | |
| Sample ID | Liquid pure | + | + | CFU/mL |
| Pseudomonas | culture | | | 3.15 × 10⁵ |
| protegens | | | | |
| Sample ID | Liquid pure | + | + | CFU/mL |
| Pseudomonas | culture | | | 3.15 × 10⁵ |
| putida | | | | |
| Sample ID | Liquid pure | + | + | CFU/mL |
| Pseudomonas | culture | | | 3.15 × 10⁵ |
| palustris | | | | |
| Sample ID | Liquid pure | + | + | CFU/mL |
| Paenibacillus | culture | | | 3.15 × 10⁵ |
| durus | | | | |
| Sample ID | Liquid pure | + | + | CFU/mL |
| Lactobacillus | culture | | | 3.15 × 10⁵ |
| plantarum | | | | |
| Sample ID | Liquid pure | + | + | CFU/mL |
| Bacillus firmus | culture | | | 3.15 × 10⁵ |
| Sample ID | Liquid | + | + | CFU/mL |
| Composition 1A | mixed | | | 3.15 × 10⁵ |
| (from Table 1A) | culture | | | |

### Example 3: Testing Isolated Microbes and Microbial Consortia for Nitrogen Fixation Ability

The bacteria for this Example were grown in the appropriate liquid media Tryptic Soy, Luria Broth or Nutrient broth for 24 h-72 h hours. The liquid culture was then spun down at 13000 rpm and the supernatant discarded. The pellet was then washed with 100 Saline and the centrifuge process was repeated 3 times with 1% saline. After the final wash the cells were resuspended to produce the samples that contained the isolated microbes set forth in Table 6 below and the microbial consortium disclosed in Table 1A above.

Qualitative assays of nitrogen fixation ability were performed on Jensen's Nitrogen limiting agar and Ashby's Mannitol Agar. Nitrogen-fixing organisms are free-living bacteria, which grow well on a nitrogen free agar plate. The bacteria utilize atmospheric nitrogen gas for their cell protein synthesis. The ability for a bacterium to grow on either of the nitrogen limiting plates shows the ability of the bacteria to affix atmospheric nitrogen gas.

Ashby medium containing (per 11): 20 g mannitol, 0.2 g K2HPO4, 0.2 g MgSO4-7H2O, 0.2 g NaCl, 0.1 g K2SO4, 5 g CaCO3, 15 g agar Jensen's nitrogen glucose limiting agar. Glucose 20 g/L, K2HPO4 1 g/L, CaCl2 0.1 g/L, NaCl 0.5 g/L, MgSO4*7H2O 0.25 g, FeSO4*7H2O 1.01 g/L, Na2MoO4*2H2O 0.01 g/L, MnSO4*5H2O 0.01 g/L, Agar 20 g/L, 0.500 Bromothymol blue alcoholic solution 2 mL.

For point inoculation, 24 h grown bacterial cultures were pelleted by centrifuging at 5000×g, and the pellets were dissolved in PBS with necessary adjustments made to attain an inoculation load of 3.15×105 cfu/mL. The plates were incubated at 28° C., for 7 to 14 d. Halo zone size was determined by subtracting the total zone diameter from the colony diameter as described earlier.

Ashby medium containing (per 1 L): 20 g mannitol, 0.2 g K2HPO4, 0.2 g MgSO4-7H2O, 0.2 g NaCl, 0.1 g K2SO4, 5 g CaCO3, 15 g agar (Brown et al., 1962; Knowles, 1982); Results of these tests are set forth in Table 6 below.

TABLE 6

| | | Jensen's | | |
|---|---|---|---|---|
| | | Nitrogen | Ashby's | |
| | | Limiting | Mannitol | |
| Analysis | Received As | Agar | Agar | Avg CFU/mL |
| Sample ID | Liquid pure | + | + | CFU/mL |
| Bacillus | culture | | | 3.15 × 10⁵ |
| mojavensis | | | | |
| Sample ID | Liquid pure | + | + | CFU/mL |
| Pseudomonas | culture | | | 3.15 × 10⁵ |
| protegens | | | | |
| Sample ID | Liquid pure | + | − | CFU/mL |
| Pseudomonas | culture | | | 3.15 × 10⁵ |
| putida | | | | |
| Sample ID | Liquid pure | + | + | CFU/mL |
| Pseudomonas | culture | | | 3.15 × 10⁵ |
| palustris | | | | |
| Sample ID | Liquid pure | + | + | CFU/mL |
| Paenibacillus | culture | | | 3.15 × 10⁵ |
| durus | | | | |
| Sample ID | Liquid pure | + | + | CFU/mL |
| Lactobacillus | culture | | | 3.15 × 10⁵ |
| plantarum | | | | |
| Sample ID | Liquid pure | + | + | CFU/mL |
| Bacillus firmus | culture | | | 3.15 × 10⁵ |
| Sample ID | Liquid | + | + | CFU/mL |
| Composition 1A | mixed | | | 3.15 × 10⁵ |
| (from Table 1A) | culture | | | |

In more detail, the agar plates used in this Example lack a nitrogen source. Therefore, nitrogen fixation is confirmed with growth on plates: if bacteria grow on test plates it confirms their ability to affix atmospheric nitrogen since no other nitrogen source is available for their growth.

### Example 4: Nutrient Levels in Whole Plant Samples Comparing Microbial Consortium Treatment and Control

A population of Rutgers tomato plants was grown in a standard greenhouse and used as the test population and the control population for this Example and for the Examples that follow. For this Example, the test population was treated with 50 mL of Composition 1A as set forth in Table 1A, where the fluid carrier is a solution of water with citric acid added in an amount of 1.5 gm/L. No other agricultural treatments were applied. A control population was grown under the same conditions as the test population but was only treated with water and with no other agricultural treatments. At the conclusion of the study, all plants were harvested, and certain macronutrient and micronutrient levels were measured in the whole plant tissue.

Tomato plants for pot trials were grown in 2×2 inch mineral wool blocks. The mineral wool was seeded with 3 seeds per block. After the first seedling emerged from each block any other seedlings were cut away if they emerged after the initial. The tomato seedlings were transplanted to 12 inch mesh grow bags two weeks after first emergence. A total of 6 pots were tested for each soil amendment. The seedlings were treated with appropriate volume 50 ml of Composition 1A (as set forth in Table 1A), water or Positive control based on volume of dirt in 12-inch mesh grown bag. The pots of tomatoes were placed in grow tents with a 12-hour light and dark cycle. The water schedule was 250 mL of sterile water every other day for the continuation of the experiment. The biologicals that were tested were applied every 3 weeks from the initial treatment. The growth cycle of the plant was concluded when fruit emerged on the plants. At this time the plants were harvested to measure roots mass and conduct tissue analysis. The plants were measured for height, leaves, flowers, fruits, tap root length, lateral root length, and time for seedlings and fruit to emerge. The plant from above the soil stem, leaves and flowers were separated from the roots and sent for tissue analysis of nutrients. The roots were removed from the pots after separation and wash in RO water and the water discarded. This was repeated until the roots contained little to no residual dirt. The roots were then measured for length of tap root, lateral root, and mass of roots.

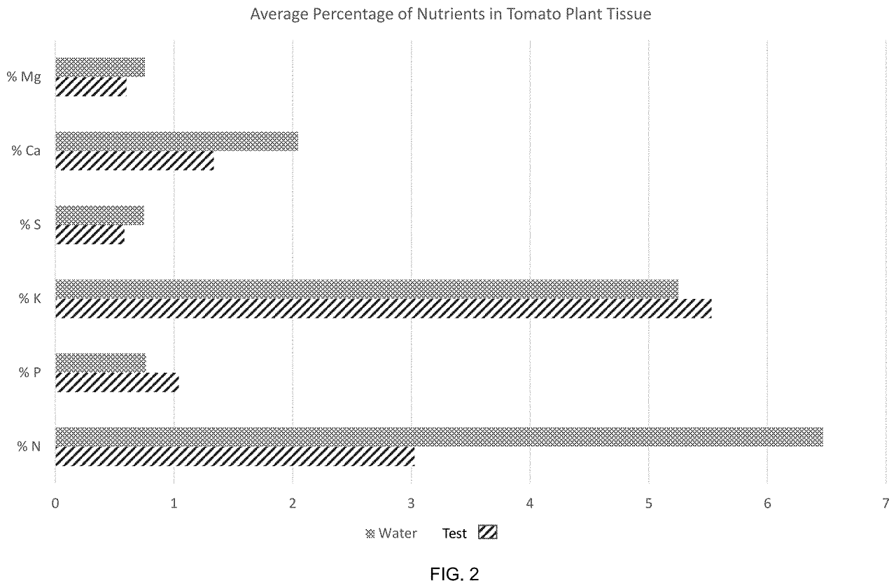

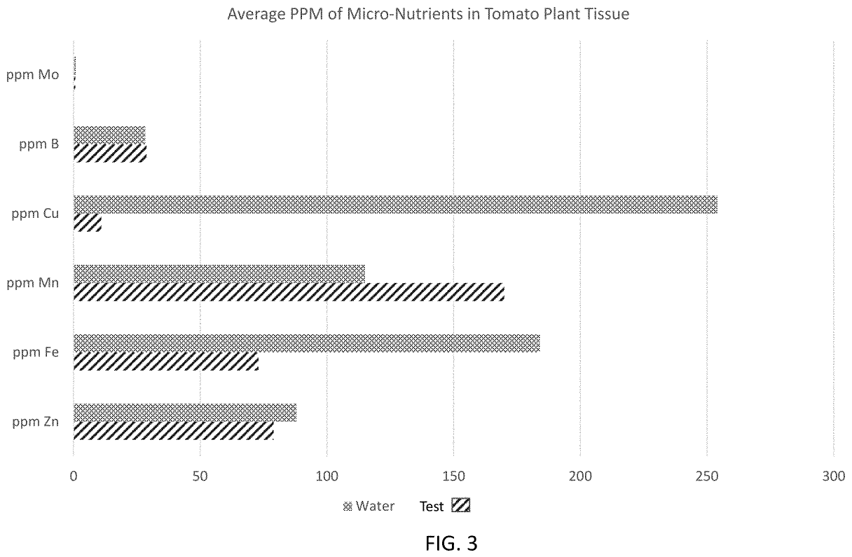

The results of these tests are shown in FIGS. 2 and 3. FIG. 2 shows the average percentage of nutrients (Mg, Ca, S, K, P, and N) in the plant tissue for the control population and the test population. FIG. 3 shows the average micronutrient values (Mo, B, Cu, Mn, Fe, and Zn) in the plant tissue for the control population and the test population.

### Example 5: Height and Flowers in Plant Populations Comparing Microbial Consortium Treatment and Control

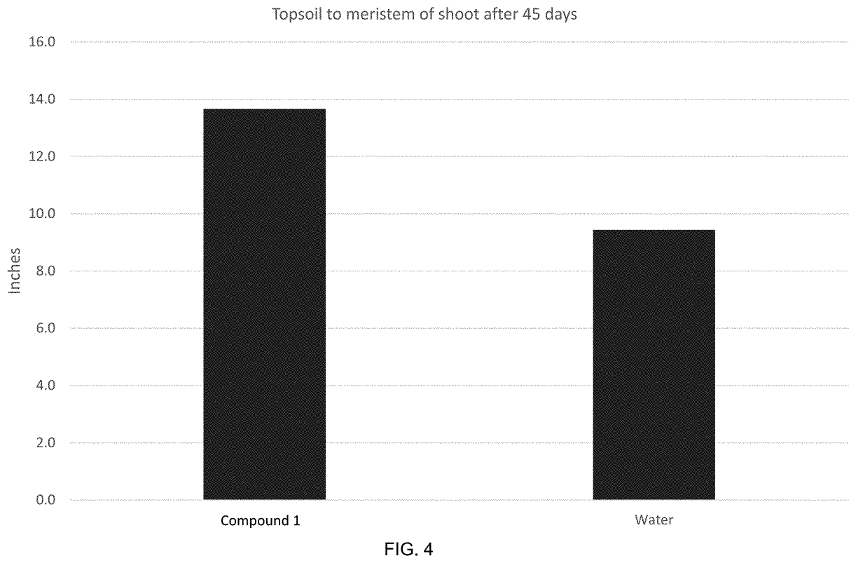

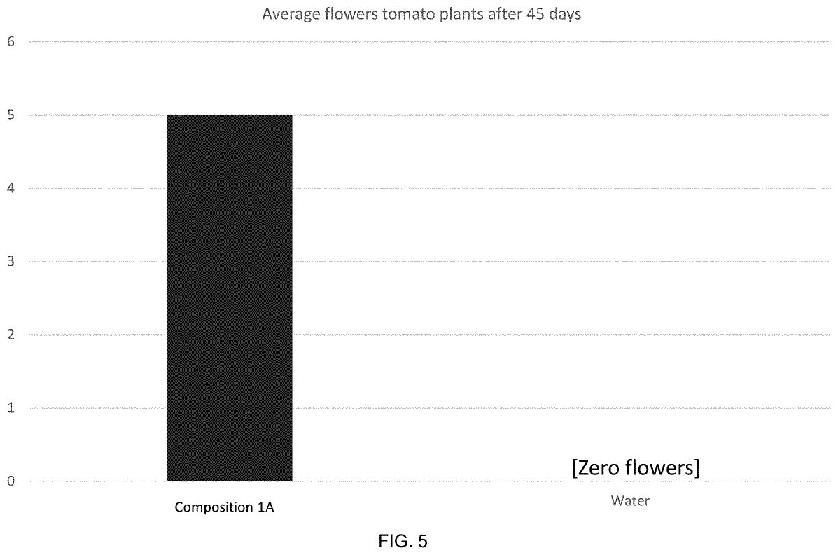

A population of Rutgers tomato plants was grown as described in Example 4, with a portion of the population treated with Composition 1A as described in Example 4 (the test population) and a portion of the population was only treated with water and with no other agricultural treatments (the control population). The height and the number of flowers on the two populations are shown on the bar graphs in FIGS. 4 and 5, where the “Composition 1A” bar represents the test population, and the “Water” bar represents the control population. In FIG. 4, the term “Compound 1” refers to Composition 1A.

### Example 6: Height of Plants Comparing Microbial Consortium Treatment and Control

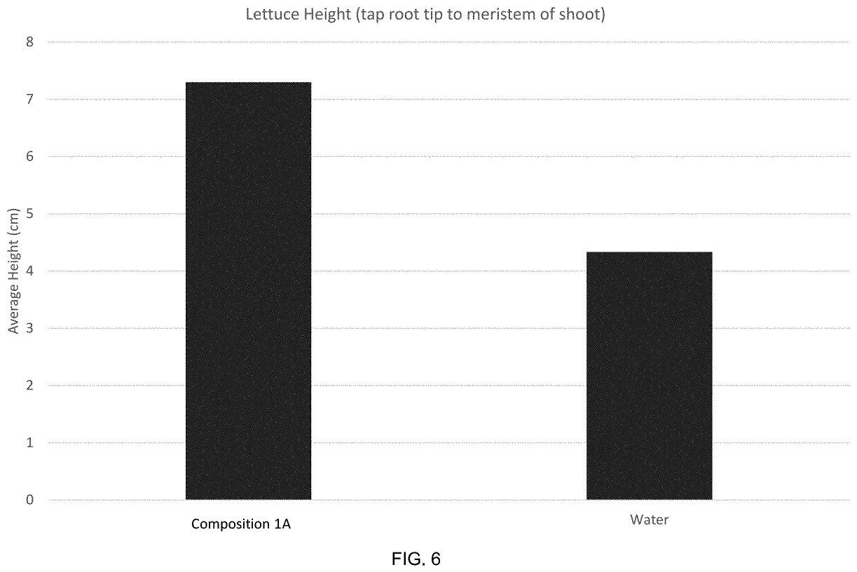

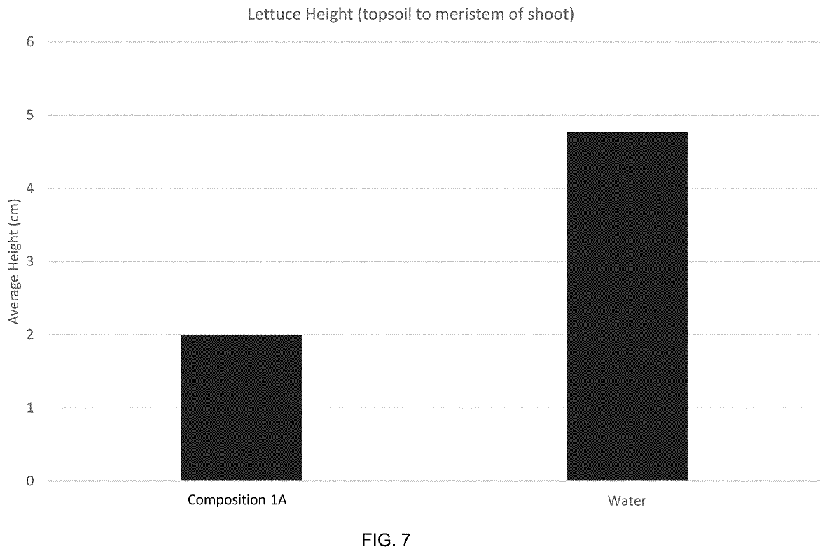

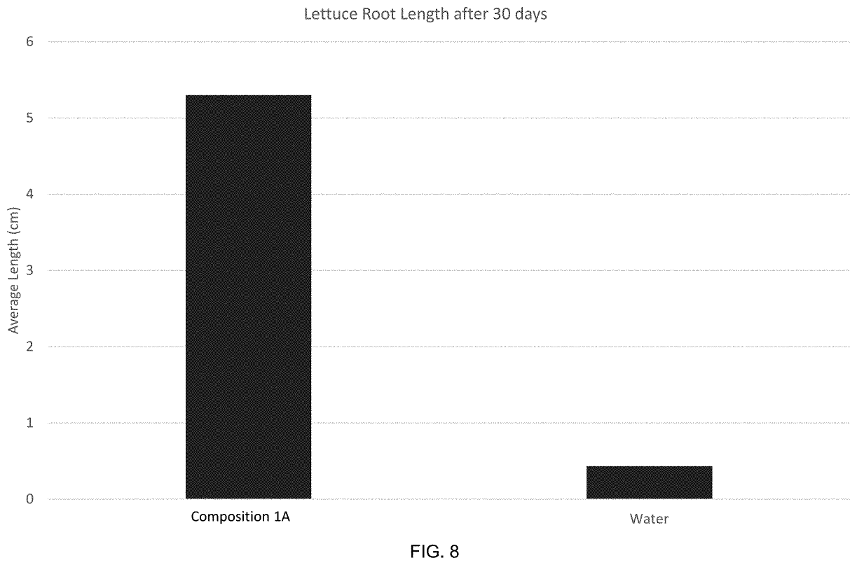

A population of Red Fire Lettuce was grown. The red leaf lettuce plants were grown for 60 days, after which they were harvested and measured to length of roots and leaves. The red fire lettuce were grown from seeds in 2×2 inch mineral wool growth blocks. The mineral wool was seeded with 6 seeds per block. After the first seedling emerged from each block any other seedlings were cut away if they emerged after the initial. All experimental conditions were performed in triplicate and the growth experiment was repeated to confirm results. The seeds were inoculated with 1 ml of Composition 1A as described in Example 4, water or positive control. The blocks were then watered with 50 ml of sterile RO water and placed in portioned domed growth trays. The blocks were watered every other day with 50 ml Sterile water. The tests plants were treated were biological amendments every 3 weeks after initial treatment until time of harvest. Red fire lettuce plants were placed under grown lights with a light cycle of 12 hours light and 12 hours dark. The lettuce remained in the mineral wool and grow tray for remainder of the experiment. At the conclusion of the experiment the mineral wool black were cut open and the lettuce was harvested. At this time measure of tap root length, lateral roots lengths, leaves number, leaves lengths and root mass were taken. A portion of the population was treated with a composition comprising the microbial consortium set forth in Table 1A (the test population), and a portion of the population was only treated with water and with no other agricultural treatments (the control population). Measurements were made of the plants in the two populations after thirty days of growth. FIG. 6 is a bar graph that shows the average height of the lettuce plants in each population, where the measurement is made from the tip of the tap root to the top of the meristem of the main shoot. FIG. 7 is a bar graph that shows the average height of the lettuce plants in each population, where the measurement is made from the top of the topsoil to the tip of the meristem of the main shoot. It was observed that the control population developed longer but less stable leaves. FIG. 8 is a bar graph that shows the average length of the tap root of the lettuce plants in each population, where the measurement was made from the topsoil to the tip of the main tap root. Taken together, these graphs show that the plants treated with the test formulation (i.e., the test populations) are more balanced, with longer roots and a shorter top—overall qualitatively a better set of plants.

### Example 7

A field study was conducted as follows, between January and April 2021. A 40-acre farm of orange citrus and other varieties of citrus trees in Edinburg, Tex. was selected as the site for the field study. Initially 5 acres (the test plot) were used for the initial field tests using Composition 2A as the test agent. The citrus trees on the test plot were planted in 2022 following the 2021 freeze event in Texas. The field study examined physical trait analysis (leaf number, root size, etc.) for the plants and soil analysis.

The test agent was applied from January 2022 to April 2022. The application rate of the test agent was 1 Pint per acre 21 days apart for a total of 3 applications. Control plots contained untreated trees. Soil samples were taken 1 week after application for soil nutrient analysis.

Plant tissue was not analyzed for this study because of the new planting and young age of the trees. However, physical traits of the trees were recorded along with soil nutrients. The treated plots were observed to have taller trees and more leaves than compared to the untreated field. The first soil nutrient analysis showed a build-up of the available potassium ready for immediate uptake. Subsequent soil nutrient analysis showed a decrease in the immediate available potassium in the soil. The untreated control soil showed a buildup of potassium immediately available throughout the study.

The build-up of potassium in the control plots' soil can be attributable to the citrus trees not absorbing the potassium. Pairing the physical traits and soil data suggests that potassium immediately available for the plants is increased with the application of the test agent. As the bacteria establish cohesion with the trees, their interaction with the trees leads to the potassium being absorbed by the trees in the test population.

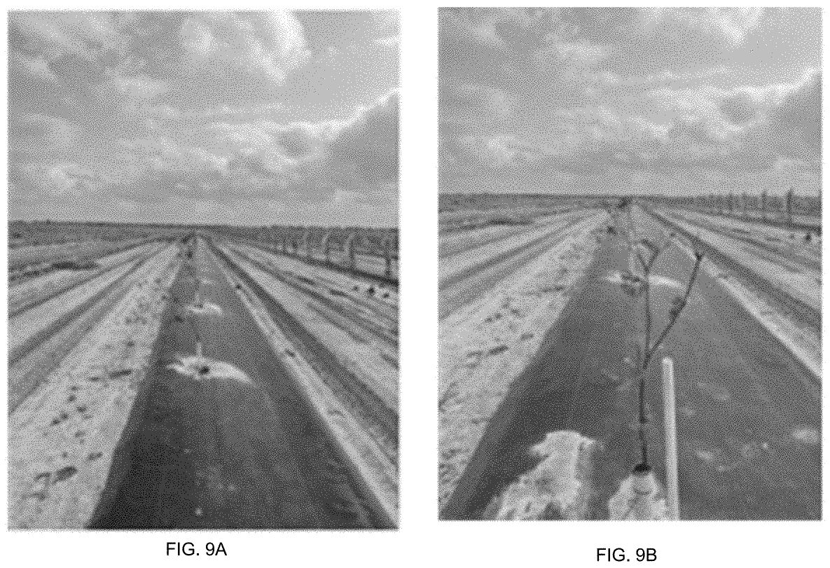

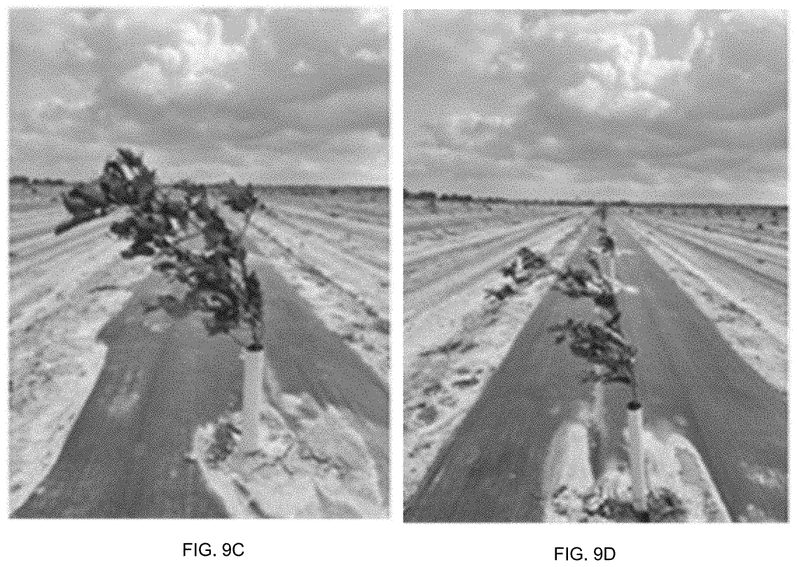

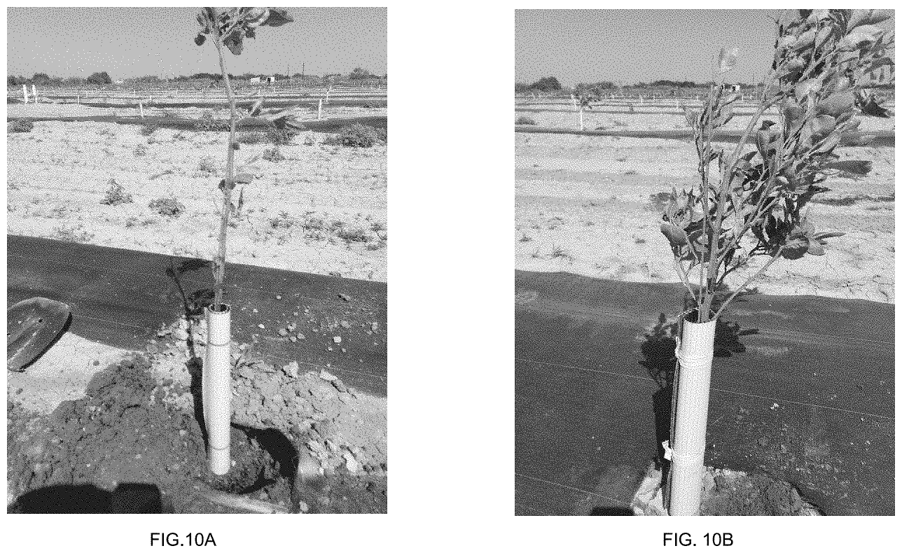

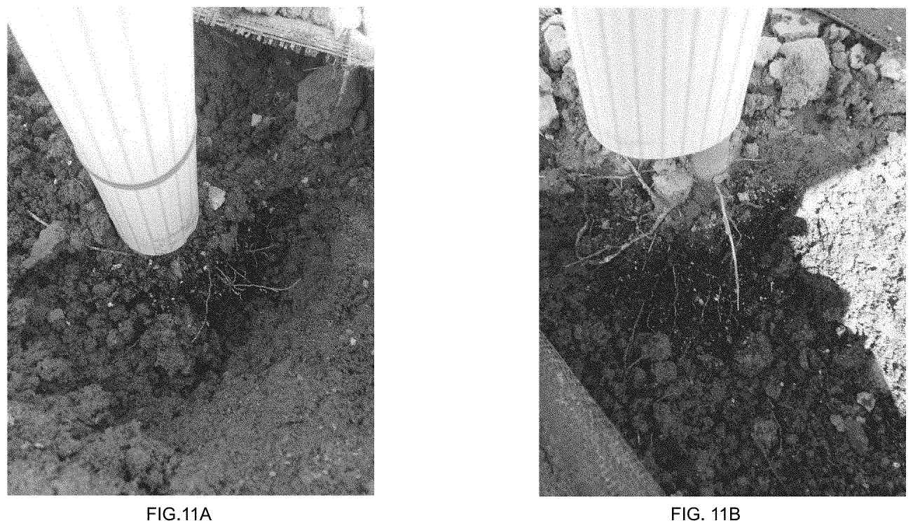

FIGS. 9A, 9B, 9C, and 9D, FIGS. 10A and 10B, and FIGS. 11A and 11B are photographs showing the differences between those treated with the test agent and the control. FIGS. 9A and 9B show untreated (control) trees, while FIGS. 9C and 9D show treated trees. FIG. 10A is a photograph of a treated tree taken on May 17, 2022, while FIG. 10B is a photograph of an untreated tree taken on the same day. FIG. 11A is a photograph of the roots of an untreated tree, while FIG. 11B is a photograph of the roots of a treated tree, showing that the treated tree has more roots and thicker roots than those of the untreated tree.

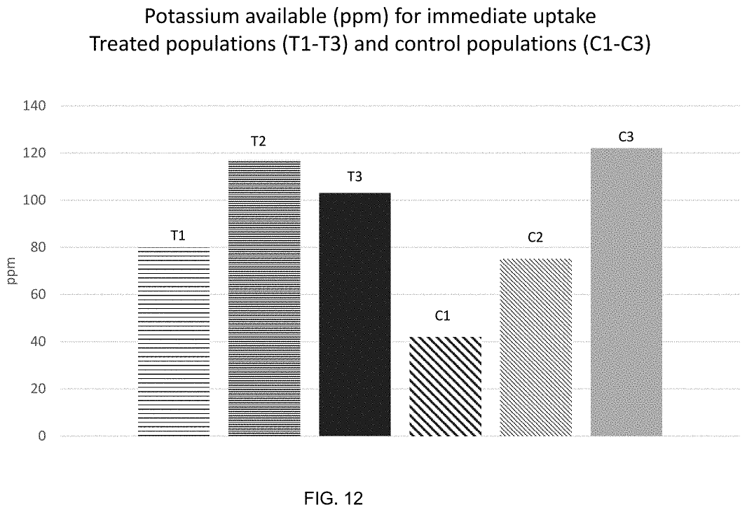

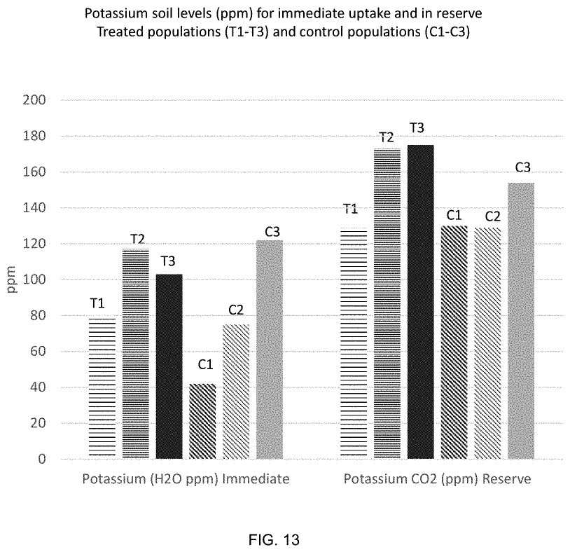

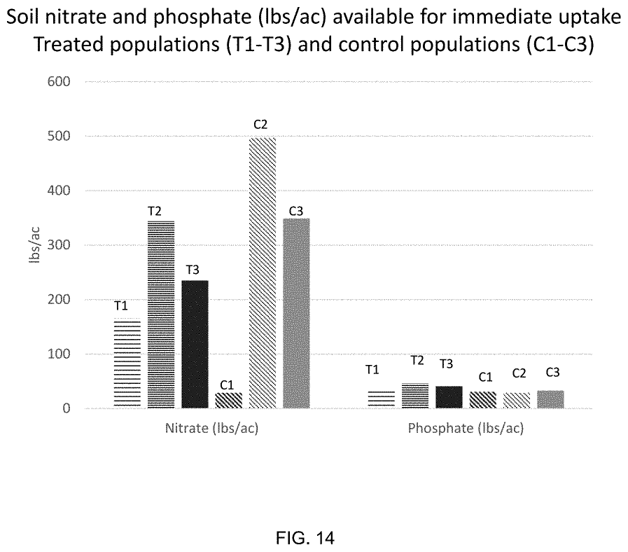

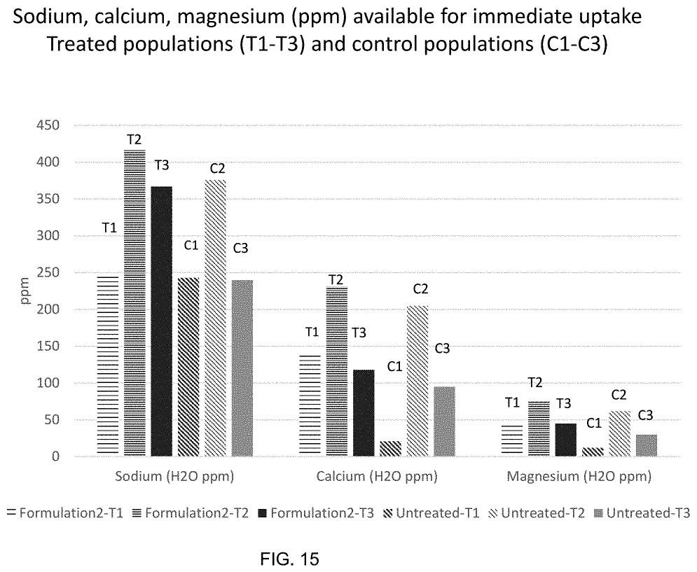

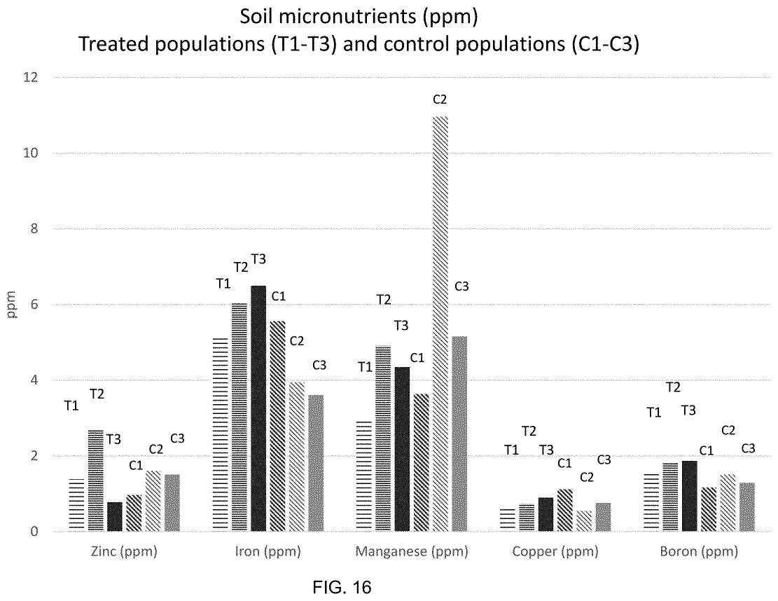

Soil analysis was performed over the course of the study. Each soil sample was taken 1 week after treatment to allow for the bacteria colonies to become established on the test plants. Applications of the test agent were administered 21 days apart. The bar graph of FIG. 12 shows the level of potassium available for immediate uptake by a plant, measured by the H2O analysis (soil extract) method. This bar graph shows the amount of potassium available in the soil in parts per million (ppm) after the following treatments: T1, T2, and T3 are measurements made in the treated soil after applications 1, 2, and 3 of the test agent, and C1, C2, and C3 are measurements made in the control soil at the same time as contemporaneous measurements in the treated soil. The amount of potassium immediately available increases at each measurement in the control population, while the amount of potassium immediately available increases then starts to decrease in the test population as the treated trees begin to absorb the nutrients from the soil. This can be attributed to the lack of bacteria for nutrient absorption in the control population, allowing the available potassium to build up in the soil; by contrast, the test population absorbs the potassium from the soil so that the amount available for immediate uptake decreases. The bar graph of FIG. 13 shows, on the left, the amount of potassium available for immediate uptake in each population as shown in FIG. 12, and contrasts it, as shown on the right, with the amount of potassium in reserve in the soil (measured by the CO2 method using carbonic acid extract). The reserve potassium in the soil is higher in the treated plots than in the control plots. FIG. 14 shows the soil nitrate and the soil phosphate available for uptake in the treated (T) and the control populations (C), measured at times T1, T2, and T3 and at times C1, C2, and C3, respectively. FIG. 15 shows the levels of sodium, calcium, and magnesium available for uptake in the treated (T) and the control populations (C), measured at times T1, T2, and T3 and at times C1, C2, and C3, respectively. In FIG. 15, the term “Formulation 2” refers to Composition 2A. FIG. 16 shows the levels of various micronutrients (zinc, iron, manganese, copper and boron) available for uptake in the treated (T) and the control populations (C), measured at times T1, T2, and T3 and at times C1, C2, and C3, respectively.

### Example 8

A field study was conducted as follows. A farm in Erie County NY with fields growing triticale grain was selected as the site for the field study. Two test agents were studied, Composition 1A and Composition 2A, and were compared to untreated controls. The fields were treated with the test agents once in early Winter and three applications in the Fall three weeks apart, for a total of four applications. The application rate was 1 Pint per acre. Application followed a rotating grid design as per the example. Replicates of each product in no less than three 10 ft×10 ft squares.

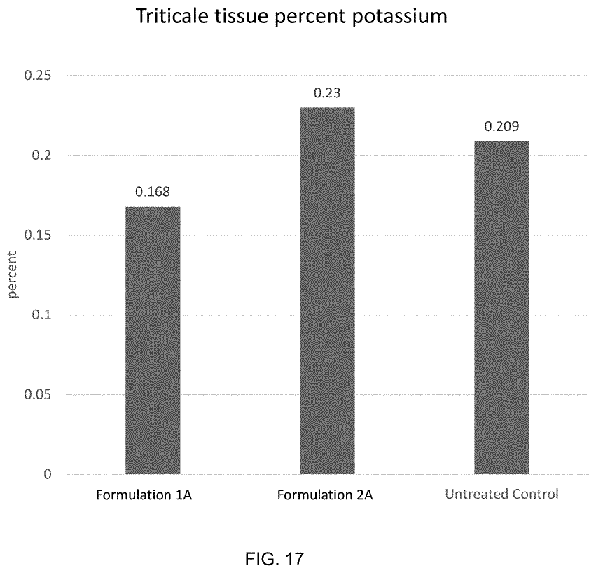

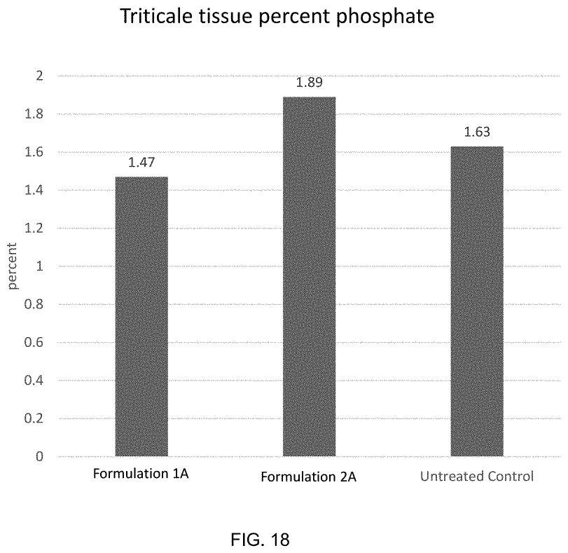

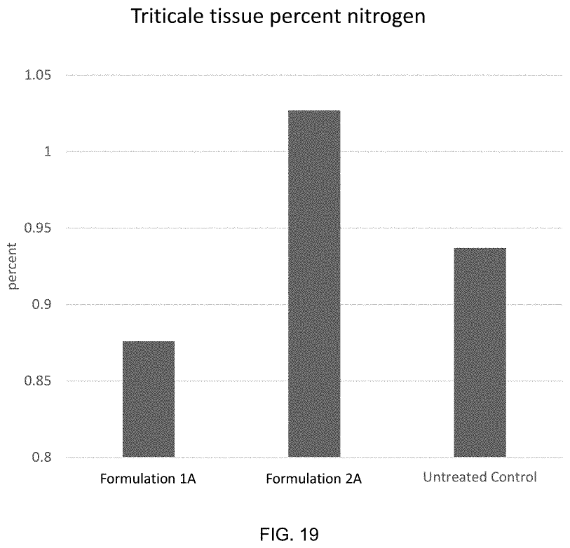

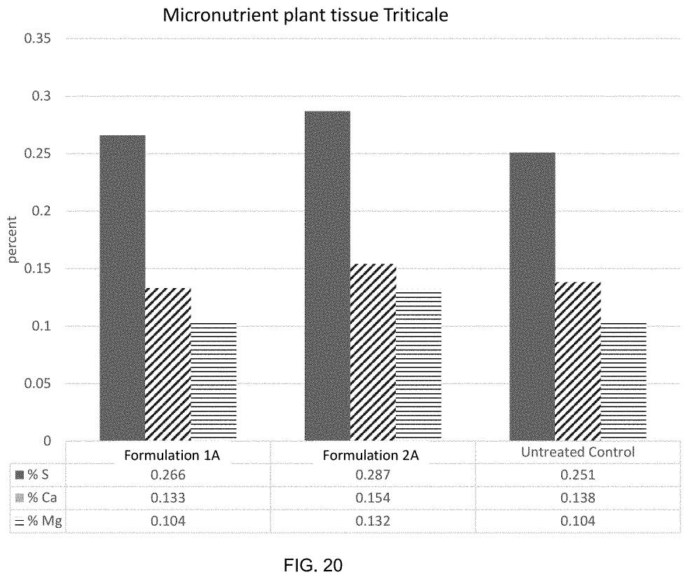

The triticale tissues for each population were analyzed at the time of harvest in February 2022. This analysis showed elevated potassium in the treated plants over those that were untreated. These results are shown in FIG. 17. The test agent also had the secondary advantage of elevating the levels of other beneficial nutrients such as Phosphate, Nitrogen, and other macronutrients, as shown in FIGS. 18, 19, and 20. In FIGS. 17-20, the terms “Formulation 1A” and “Formulation 2A” refer to Composition 1A and Composition 2A respectively.

### Example 9

A field study was conducted as follows. A farm in Erie County, NY, with fields growing winter wheat was selected as the site for the field study. Two test agents were studied, Composition 1A and Composition 2A, and were compared to untreated controls. The fields were treated with the test agents once in early Winter and three applications in the Fall three weeks apart, for a total of four applications. The application rate was 1 Pint per acre. Application followed a rotating grid design as per the example. Replicates of each product in no less than three 10 ft×10 ft squares.

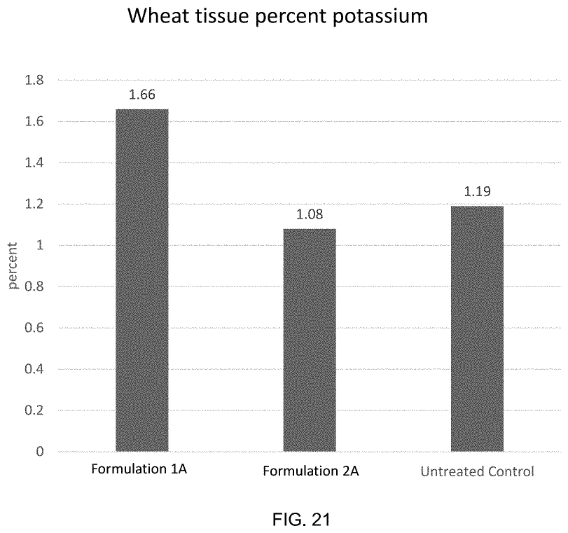

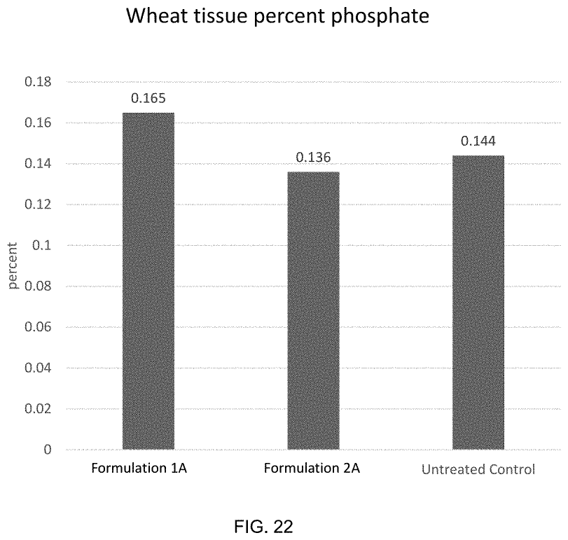

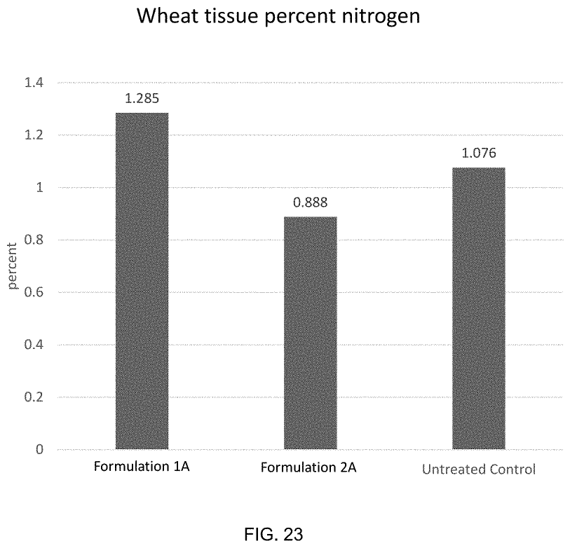

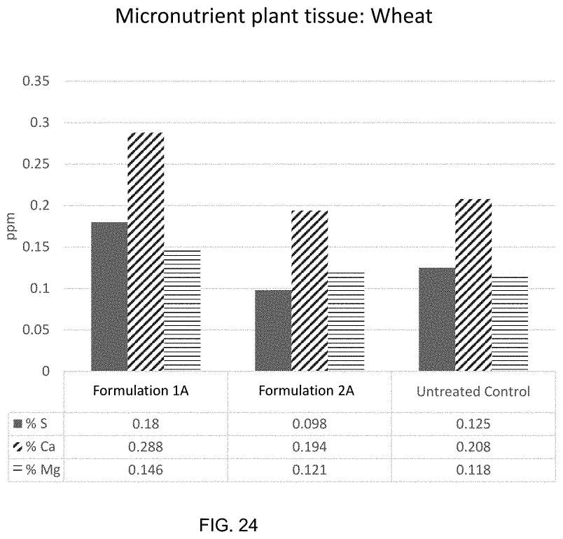

The wheat tissues for each population were analyzed at the time of harvest. This analysis showed that those plants treated with Composition A had higher levels of potassium as compared to the untreated control plants, as shown in FIG. 21. Composition 1A also had the secondary advantage of elevating the levels of other beneficial nutrients such as Phosphate, Nitrogen, and other macronutrients, as shown in FIGS. 22, 23, and 24. In FIGS. 21-24, the terms “Formulation 1A” and “Formulation 2A” refer to Composition 1A and Composition 2A respectively. In all tissue samples, Composition 2A performed less well than Composition 1A and less well than the untreated controls.

### Example 10

A field study was conducted as follows. A greenhouse in Jalisco, Mexico growing tomato plants was selected as the site for the field study. Composition 2A was used as the test agent. The purpose of the trial was to ascertain the percent of fertilizer reduction that can be achieved while maintaining yields when a Composition 2A is applied. For the study, 1 pint per acre of Composition 2A was applied to the tomato plants every 7 days for three applications, in combination with urea fertilizer. Different loads of fertilizer were used in combination with the applications of Composition 2A to populations of tomato plants. Five test populations of tomato plants were prepared, one group that was treated only with Composition 2A, and four groups that were treated with Composition 2A plus varying doses of fertilizer: 100% of the normal fertilizer dose, 75% of the normal fertilizer dose, 50% of the normal fertilizer dose, and 25% of the normal fertilizer dose. A control population was treated only with 100% of the normal fertilizer dose without any Composition 2A being applied. Each test population and the control population consisted of two rows of tomato plants, with the plants being grown in individual pots in each row. On average, there were six plants in each test population and in the control population.

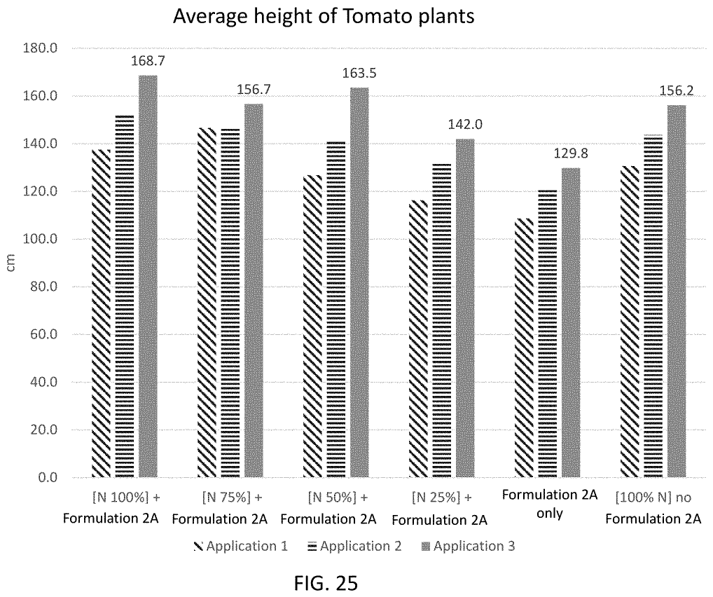

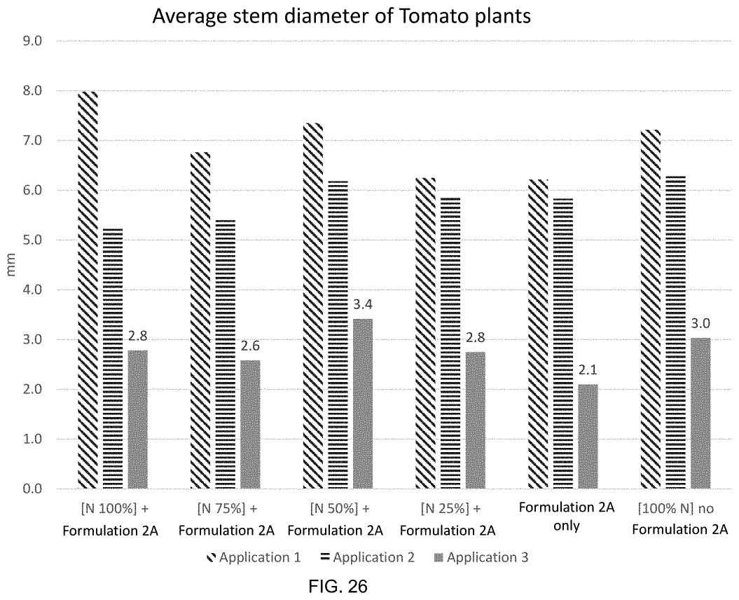

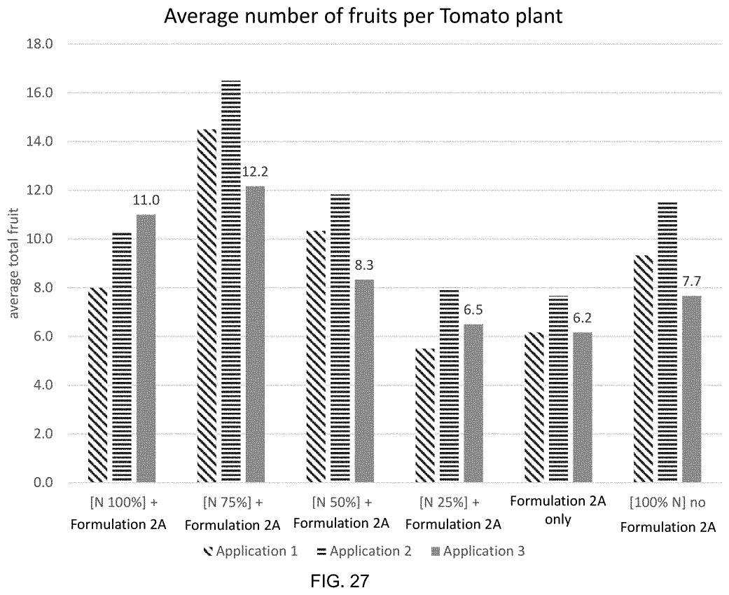

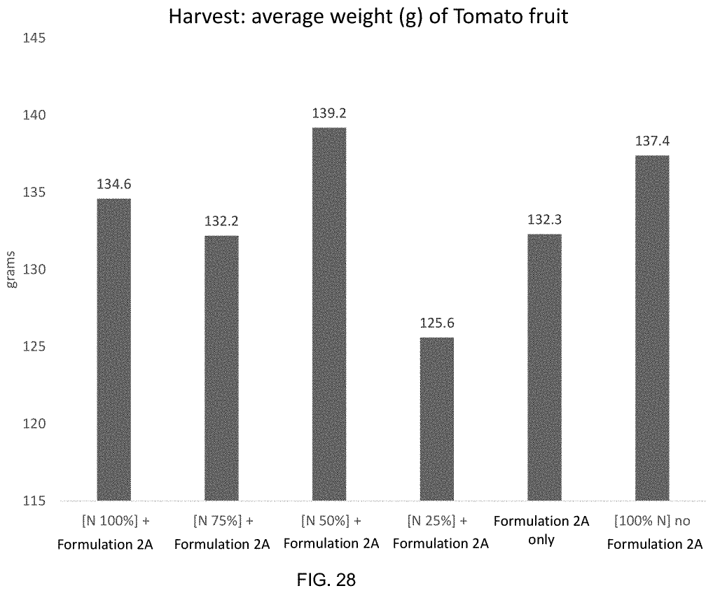

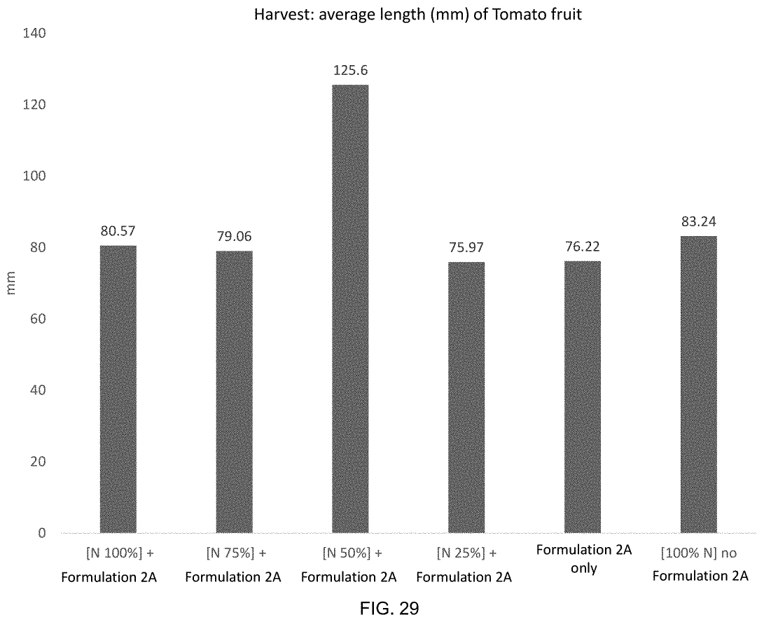

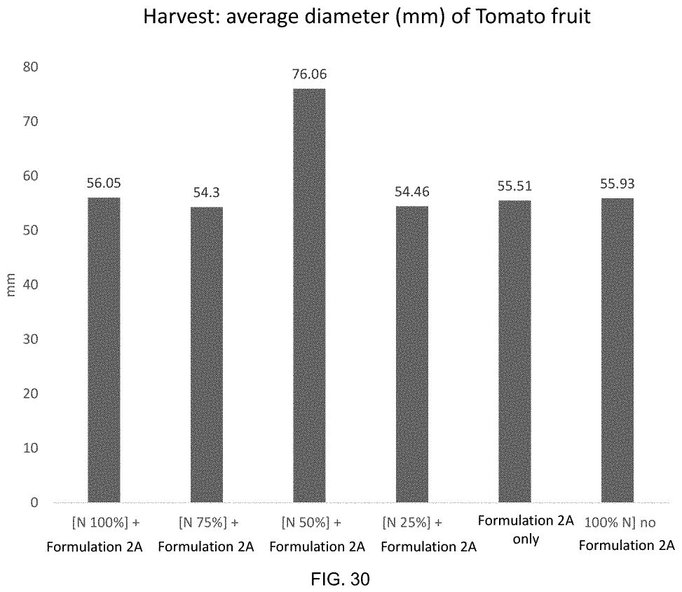

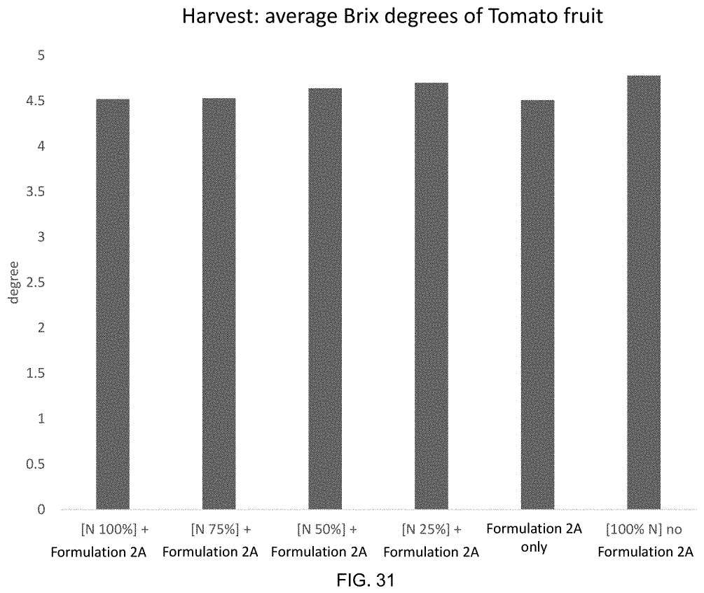

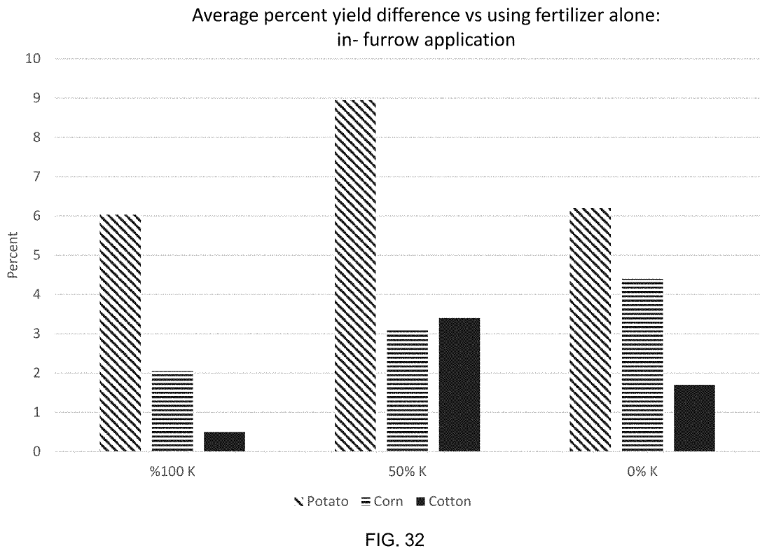

Measurements of certain plant traits indicative of plant yield were made before the treatments were begun and following each treatment. Results of these measurements are shown in FIG. 25 (average height), FIG. 26 (stem diameter), FIG. 27 (average number of fruits per plant). Measurements of plant traits indicative of fruit quality were made at harvest for each population, as shown in FIG. 28 (average weight of harvested fruits from each plant at harvest), FIG. 29 (average length of tomato fruits from each plant at harvest), FIG. 30 (average diameter of tomato fruits from each plant at harvest), and FIG. 31 (average Brix degrees of tomato fruits). In FIGS. 25-31, the term “Formulation 2A” refers to Composition 2A.

These results demonstrated that use of Composition 2A with urea fertilizer was able to reduce the fertilization used by as much as 50% while maintaining plant yield and fruit quality.

### Example 11

A multistate field trial was conducted as follows. Composition 1A was applied to a variety of plant crops in conjunction with potassium fertilizer applied at 100%, 50% and 0% of the latter's normal dose, with the test populations being compared to a control population that was treated with potassium fertilizer alone. In-furrow application of Composition 1A was also compared to side-dress application in certain plant populations. The plant crops selected for the field trials are listed in in Table 7 below:

TABLE 7

| Crop | State |
|---|---|
| Corn | WI |
| Corn | IN |
| Corn | SD |
| Corn | IL |
| Potato | WA |
| Potato | MI |
| Cotton | TX |
| Cotton | TX |
| Almond | CA |
| Almond | CA |
| Grapes | CA |
| Grapes | OR |
| Tomato | CA |
| Peppers | CA |

The protocol for the field testing is set forth below:

Row Crops: (With 100%, 50%, and 0 K Applied)

In-Furrow Corn, Cotton, & Potato: 16 fl oz/ac In-Furrow at Planting

Side-Dress Corn: 16 fl oz/ac @ growth stages V6-V8

Side-Dress Cotton: 16 fl oz/ac @ First Square & First Bloom

Side-Dress Potato: 16 fl oz/ac @ Mid Vegetative, Tuber Initiation, & Tuber Bulking

Specialty Crops: (With 100%, 50%, and 0 K Applied)

Almond: 16 fl oz/ac injected March, April, & May

Grapes: 16 fl oz/ac injected April, May, & June

Peppers & Tomato: 16 fl oz/ac in row at planting, 8-12″ tall (side-dress), & Fruit set (side-dress)

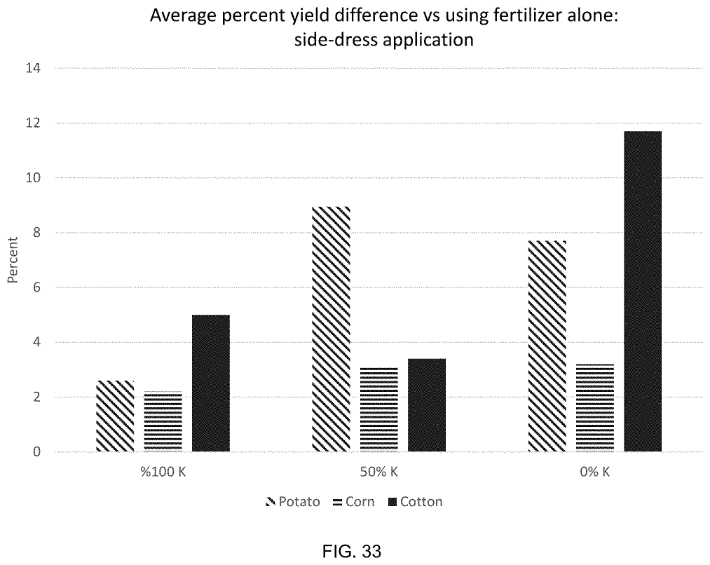

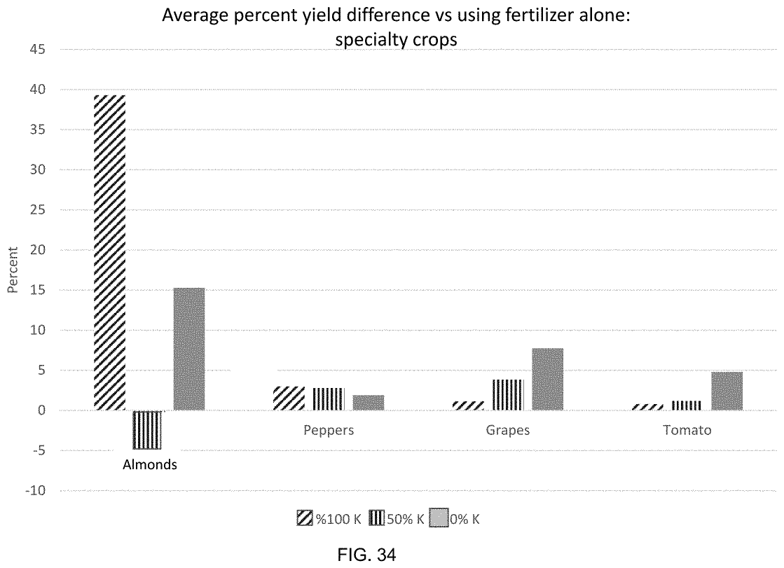

The percentage yield difference between combined application of Composition 1A and various amounts of potassium fertilizer vs application of potassium fertilizer alone for potato, corn, and cotton crops is shown in the following graphs: FIG. 32 (comparing in-furrow application of Composition 1A plus varying amounts of potassium fertilizer vs. potassium fertilizer application alone) and FIG. 33 (comparing side-dress application of Composition 1A plus varying amounts of potassium fertilizer vs. potassium fertilizer application alone). The percentage yield difference between combined application of Composition 1A and various amounts of potassium fertilizer vs application of potassium fertilizer alone for almond trees, grapes, pepper plants and tomato plants is shown in FIG. 34.

While this invention has been particularly shown and described with references to preferred embodiments thereof, it will be understood by those skilled in the art that various changes in form and details may be made therein without departing from the scope of the invention encompassed by the appended claims.

1. A composition comprising a microbial consortium, wherein the microbial consortium comprises one or more constitutive isolated microbes selected from the group consisting of Pseudomonas putida, Bacillus mojavensis, Rhodopseudomonas palustris, Pseudomonas protegens, and Lactobacillus plantarum.

2. (canceled)

3. The composition of claim 1, wherein the microbial consortium comprises at least three isolated microbes selected from the group consisting of Pseudomonas putida, Bacillus mojavensis, Rhodopseudomonas palustris, Pseudomonas protegens, and Lactobacillus plantarum.

4. The composition of claim 3, wherein the microbial consortium comprises at least four isolated microbes selected from the group consisting of Pseudomonas putida, Bacillus mojavensis, Rhodopseudomonas palustris, Pseudomonas protegens, and Lactobacillus plantarum.

5. The composition of claim 4, wherein the microbial consortium comprises Pseudomonas putida, Bacillus mojavensis, Rhodopseudomonas palustris, Pseudomonas protegens, and Lactobacillus plantarum.

6. The composition of claim 4, wherein the microbial consortium consists essentially of Pseudomonas putida, Bacillus mojavensis, Rhodopseudomonas palustris, Pseudomonas protegens, Bacillus amyloliquefaciens, Bacillus subtilis, and Bacillus lichenformis.

7. The composition of claim 4, wherein the microbial consortium consists essentially of Pseudomonas putida, B. mojavensis, Rhodopseudomonas palustris, P. protegens, P. durus, Lactobacillus plantarum, and Bacillus firmus.

8. The composition of claim 1, further comprising at least one isolated non-constitutive microbe.

9. The composition of claim 8, wherein the at least one isolated non-constitutive microbe is Paenibacillus durus or Bacillus firmus.

10. The composition of claim 8, wherein the microbial consortium does not comprise Paenibacillus durus or Bacillus firmus.

11. The composition of claim 8, wherein the at least one isolated non-constitutive microbe is selected from the group consisting of Pseudomonas fluorescens, Bacillus coagulans, Bacillus amyloliquefaciens, Bacillus subtilis, Bacillus lichenformis, Bacillus brevis, Alicaligenes faecalis, Pseudomonas denitrificans, Burkholderia species, Bacillus pumilus, Bacillus cereus, Bacillus megaterium, and Bacillus thuringiensis.

12. A formulation comprising the composition of claim 1 and an agriculturally compatible carrier.

13. The formulation of claim 12, wherein the formulation is a fluid formulation selected from the group consisting of a liquid, an emulsion, a suspension, a solution, a gel, an irrigation vehicle, a spray vehicle, and a seed coating vehicle.

14. (canceled)

15. The formulation of claim 13, wherein the agriculturally compatible carrier is a n aqueous carrier.

16. The formulation of claim 12, wherein the formulation is a solid formulation selected from the group consisting of a wettable powder, a solid powder, a dusting powder, a tablet, water-dispersible granules, water-soluble granules, and microencapsulated granules.

17. (canceled)

18. The formulation of claim 12, further comprising an agriculturally compatible additive selected from the group consisting of preservatives, surfactants, emulsifiers, stabilizers, buffers, acidifiers or alkalinizing agents, nutrients, thickening agents, gelling agents, dispersants, antifreeze agents, dyes, colorants, pesticides, herbicides, insecticides, fungicides, and antibacterial agents.

19-21. (canceled)

22. A method of treating an agricultural target, comprising delivering a treatment to the agricultural target comprising an amount of the formulation of claim 12 effective for obtaining a desired result, thereby producing a treated agricultural target demonstrating the desired result, wherein the desired result is selected from the group consisting of an improvement of a pathological condition, an avoidance of the pathological condition, an inhibition of an undesirable condition, a protection against the undesirable condition, a prevention of worsening of the undesirable condition, a stabilization of the undesirable condition, a reversal of the progression of the undesirable condition, a slowing of the progression of the undesirable condition, and a delay of the progression of the undesirable condition.

23-25. (canceled)

26. The method of claim 22, wherein the stress condition is an exposure to salt-affected soil or a drought condition.

27. (canceled)

28. The method of claim 22, wherein the pathological condition is selected from the group consisting of a disease state, an infection, a chemical exposure, drought conditions or a lack of adequate water, and deleterious effects due to an exposure to excess heat or cold.

29. The method of claim 22, wherein the desired result is an enhancement of a healthy condition, wherein the enhancement of the healthy condition is identified by comparing a state of the treated agricultural target with the state of a control agricultural target, wherein the control agricultural target has been exposed to conditions similar to those for the treated agricultural target, but without receiving the treatment.

30. (canceled)

31. The method of claim 22, further comprising delivering a secondary treatment in combination with the treatment, wherein the secondary treatment is selected from the group consisting of fertilizers, pesticides, and herbicides.

32. (canceled)

33. (canceled)

34. A method of effecting a beneficial agronomic effect in an agricultural target, comprising delivering an effective amount of the formulation of claim 12 to the agricultural target, wherein the beneficial agronomic effect is selected from the group consisting of an improvement in growth, an increase in yield, improved metabolism, improved stress tolerance, and improvement in plant product composition.

35-40. (canceled)
